(19) United States
(12) Patent Application Publication
(10) Pub. No.: US 2024/0371173 A1
(43) Pub. Date: Nov. 7, 2024

(54) SIGNAL PROCESSING DEVICE, SIGNAL PROCESSING METHOD, AND PROGRAM

(71) Applicant: SONY SEMICONDUCTOR SOLUTIONS CORPORATION, KANAGAWA (JP)

(72) Inventor: TAKUYA YAMAGUCHI, KANAGAWA (JP)

(21) Appl. No.: 18/685,984

(22) PCT Filed: Mar. 23, 2022
(86) PCT No.: PCT/JP2022/013432

§ 371 Date: Feb. 23, 2024

(30) Foreign Application Priority Data
Sep. 13, 2021 (JP) 2021-148641

(51) Int. Cl. G06V 20/58; G06T 7/73; G06V 20/56

(52) U.S. Cl. CPC G06V 20/58; G06T 7/74; G06V 20/588; G06T 2207/10016; G06T 2207/30256

(57) ABSTRACT

To realize a configuration of analyzing a captured image captured by a monocular camera and determining whether an object in the captured image is a real object or a drawing object. An image captured by a monocular camera mounted on a vehicle is analyzed to determine whether an object in the captured image is a real object or a drawing object. An image signal analysis unit determines that an object in the captured image is a drawing object in a case where a change amount per unit time of a FOE (focus of expansion) position in the captured image is equal to or larger than a predetermined threshold value, in a case where a change amount per unit time of a lane width detected from the captured image is equal to or larger than a predetermined threshold value, or in a case where a difference between a grounding position of a vehicle or the like in the captured image and a ground level position corresponding to the vehicle grounding position is equal to or larger than a predetermined threshold value.

### TECHNICAL FIELD

The present disclosure relates to a signal processing device, a signal processing method, and a program. More specifically, the present disclosure relates to a signal processing device, a signal processing method, and a program for analyzing whether or not an object in an image captured by a camera is not a real object such as an actual road but a drawing object such as a photograph or a picture in a device that analyzes an image captured by a camera and automatically travels, such as an automated vehicle, for example.

### BACKGROUND ART

In recent years, various driving assistance systems such as automatic braking, automatic speed control, and obstacle detection have been developed, and the number of automated vehicles that do not require driver's operation and vehicles equipped with a driving assistance system that reduces driver's operation is expected to increase in the future.

For safe automated driving, it is necessary to reliably detect various objects that become obstacles to movement such as a vehicle, a pedestrian, and a side wall.

The object detection processing in an automated vehicle is often performed, for example, by analyzing an image captured by a camera provided in the vehicle.

A captured image in a traveling direction of a vehicle is analyzed, and various objects such as an oncoming vehicle and a preceding vehicle as obstacles, a pedestrian, and a street tree are detected from the captured image, thereby controlling a path and a speed to avoid collision with these objects.

Moreover, a center line, a side strip, a lane boundary line, and the like on a road are detected to perform a traveling path control for traveling at a position separated from these lines by a certain distance.

By controlling a traveling direction, a speed, and the like of a vehicle on the basis of the detection information of the objects and lines in this manner, safe automatic traveling is realized.

Note that, for example, there is Patent Document 1 (WO 2020/110915) as a conventional technique that discloses the automated driving based on an image captured by a camera.

However, in a case where the camera is not a camera capable of calculating a highly accurate object distance, such as a stereo camera, for example, but is a monocular camera, the following problem occurs in the traveling control based on an image captured by the camera.

For example, in a case where an automated vehicle attempting to park in a parking lot enters the parking lot and a camera of the vehicle captures an image of a photograph of a road attached to a wall of the parking lot, a distance to a “drawing object” such as the photograph or a picture cannot be calculated. Therefore, there is a possibility that a road drawn in the “drawing object” is erroneously recognized as a real road. If such erroneous recognition occurs, the automated vehicle collides with the wall in an attempt to travel on the road in the photograph on the wall.

### CITATION LIST

### Patent Document

Patent Document 1: WO2020/110915 A1

### SUMMARY OF THE INVENTION

### Problems to be Solved by the Invention

In view of the above-described problem, for example, the present disclosure aims at providing a signal processing device, a signal processing method, and a program for analyzing whether or not a road or the like in an image captured by a camera is a real object or a drawing object such as a photograph or a picture.

### Solutions to Problems

A first aspect of the present disclosure is a signal processing device, including
an image signal analysis unit configured to input a captured image captured by a monocular camera mounted on a vehicle, and determine whether an object in the captured image is a real object or a drawing object by image analysis of the input captured image.

Moreover, a second aspect of the present disclosure is a signal processing method executed in a signal processing device, the method including
executing image signal analysis processing by an image signal analysis unit of inputting a captured image captured by a monocular camera mounted on a vehicle, and determining whether an object in the captured image is a real object or a drawing object by image analysis of the input captured image.

Moreover, a third aspect of the present disclosure is a program causing a signal processing device to execute signal processing, the program causing an image signal analysis unit to perform image signal analysis processing of inputting a captured image captured by a monocular camera mounted on a vehicle, and determining whether an object in the captured image is a real object or a drawing object by image analysis of the input captured image.

Note that the program of the present disclosure is, for example, a program that can be provided by a storage medium or a communication medium that provides a variety of program codes in a computer-readable format, to an information processing apparatus or a computer system that can execute the program codes. By providing such a program in a computer-readable format, processing corresponding to the program is implemented on the information processing apparatus or the computer system.

Other objects, features, and advantages of the present disclosure will become apparent from a more detailed description based on examples of the present disclosure described later and the accompanying drawings. Note that a system described herein is a logical set configuration of a plurality of devices, and is not limited to a system in which devices with respective configurations are in the same housing.

### Effects of the Invention

According to a configuration of an embodiment of the present disclosure, there is realized a configuration of analyzing a captured image captured by a monocular camera and determining whether an object in the captured image is a real object or a drawing object.

Specifically, for example, an image captured by a monocular camera mounted on a vehicle is analyzed to determine whether an object in the captured image is a real object or a drawing object. An image signal analysis unit determines that an object in the captured image is a drawing object in a case where a change amount per unit time of a FOE (focus of expansion) position in the captured image is equal to or larger than a predetermined threshold value, in a case where a change amount per unit time of a lane width detected from the captured image is equal to or larger than a predetermined threshold value, or in a case where a difference between a grounding position of a vehicle or the like in the captured image and a ground level position corresponding to the vehicle grounding position is equal to or larger than a predetermined threshold value.

With this configuration, there is realized a configuration of analyzing a captured image captured by a monocular camera and determining whether an object in the captured image is a real object or a drawing object.

Note that the effects described herein are merely examples and are not limited, and additional effects may also be provided.

### BRIEF DESCRIPTION OF DRAWINGS

FIG. 1 is a diagram for explaining an automated vehicle and an outline of automated driving based on an image captured by a camera.

FIG. 2 is a diagram for explaining an example of an image captured by a camera of an automated vehicle.

FIG. 3 is a diagram for explaining an example of a drawing object such as a photograph or a picture of a landscape including a road or the like drawn on a wall of a parking lot.

FIG. 4 is a diagram for explaining an example of an image of a drawing object captured by a camera of an automated vehicle.

FIG. 5 is a diagram for explaining a configuration example of a signal processing device according to the present disclosure.

FIG. 6 is a diagram for explaining a detailed configuration example of an image analysis unit in an image signal analysis unit of the signal processing device according the present disclosure.

FIG. 7 is a diagram for explaining a specific example of a FOE (focus of expansion) position detected by a FOE (focus of expansion) position detector.

FIG. 8 is a diagram for explaining a specific example of a ground level (road surface position) detected by a ground level detector.

FIG. 9 is a diagram for explaining a specific example of a ground level (road surface position) detected by the ground level detector.

FIG. 10 is a diagram for explaining a specific example of a FOE (focus of expansion) position detected by the FOE (focus of expansion) position detector and a ground level (road surface position) detected by the ground level detector.

FIG. 11 is a diagram for explaining a detailed configuration example of a drawing object determination unit in the image signal analysis unit of the signal processing device according the present disclosure.

FIG. 12 is a diagram for explaining a specific example of a temporal change of a FOE (focus of expansion) position in a captured image in a case where the image captured by a camera is a real object.

FIG. 13 is a diagram for explaining a specific example of a temporal change of a FOE (focus of expansion) position in a captured image in a case where the image captured by a camera is a drawing object.

FIG. 14 is a diagram for explaining a comparison of a FOE (focus of expansion) position change state with time transition between a case where a camera of a vehicle captures an image of a real object including an actual road and a case where the camera of the vehicle captures an image of a drawing object including a road such as a photograph or a picture.

FIG. 15 is a diagram for explaining a specific example of a temporal change of a lane width of a vehicle traveling lane in a captured image in a case where the image captured by a camera is a real object.

FIG. 16 is a diagram for explaining a specific example of a temporal change of a lane width of a vehicle traveling lane in a captured image in a case where the image captured by a camera is a drawing object.

FIG. 17 is a diagram for explaining a comparison of a vehicle traveling lane lane width change state with time transition between a case where a camera of a vehicle captures an image of a real object including an actual road and a case where the camera of the vehicle captures an image of a drawing object including a road such as a photograph or a picture.

FIG. 18 is a diagram for explaining a specific example of a relation between a ground level detected from a captured image and a grounding position of a vehicle in the captured image in a case where the image captured by a camera is a real object.

FIG. 19 is a diagram for explaining a specific example of a relation between a ground level detected from a captured image and a grounding position of a vehicle in the captured image in a case where the image captured by a camera is a drawing object.

FIG. 20 is a diagram for explaining a comparison of correspondence relation change of a ground level and a grounding position of a vehicle in the captured image with time transition between a case where a camera of a vehicle captures an image of a real object including an actual road and a case where the camera of the vehicle captures an image of a drawing object including a road such as a photograph or a picture.

FIG. 21 is a diagram for explaining a detailed configuration example of an object analysis unit in the image signal analysis unit of the signal processing device according the present disclosure.

FIG. 22 is a diagram illustrating a flowchart for explaining a sequence of processing executed by the signal processing device according to the present disclosure.

FIG. 23 is a diagram illustrating a flowchart for explaining a sequence of processing executed by the signal processing device according to the present disclosure.

FIG. 24 is a diagram for explaining a hardware configuration example of the signal processing device according to the present disclosure.

### MODE FOR CARRYING OUT THE INVENTION

Hereinafter, details of a signal processing device, a signal processing method, and a program of the present disclosure will be described with reference to the drawings. Note that the description will be made in accordance with the following items.
1. Regarding outline of automated vehicle and problems of automated driving based on images captured by camera
2. Regarding specific example of configuration and processing of signal processing device according to present disclosure 3. Regarding details of configuration and processing of image analysis unit
4. Regarding details of configuration and processing of drawing object determination unit
5. Regarding details of configuration and processing of object analysis unit
6. Regarding sequence of processing executed by image signal processing device according to present disclosure
7. Regarding hardware configuration example of signal processing device according to present disclosure
8. Conclusion of configuration of present disclosure

### [1. Regarding Outline of Automated Vehicle and Problems of Automated Driving Based on Images Captured by Camera]

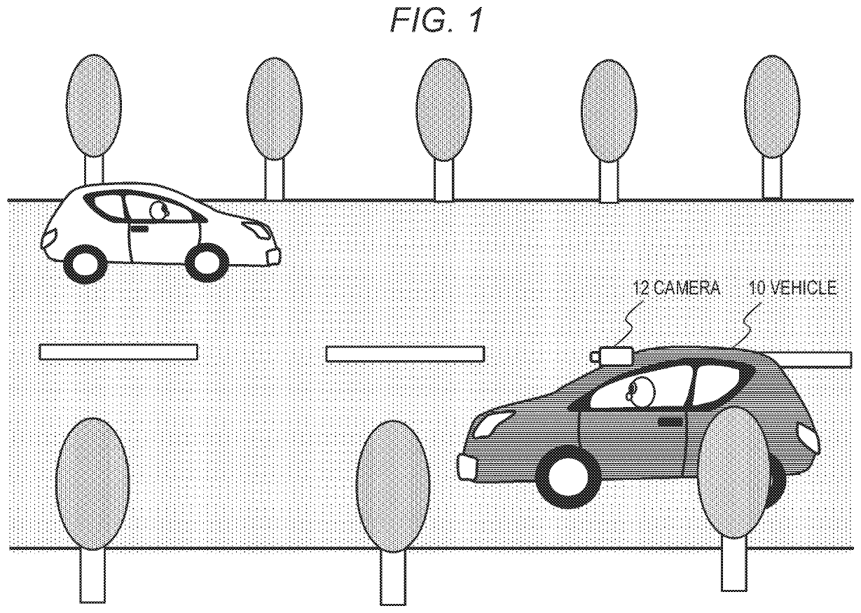

First, an outline of an automated vehicle and problems of automated driving based on images-captured by camera will be described with reference to FIG. 1 and the subsequent drawings.

FIG. 1 illustrates a vehicle 10 that performs automated driving.

A camera 12 is mounted on the vehicle 10. The vehicle 10 performs automated driving while searching for a safe traveling path by analyzing an image captured by the camera 12 and detecting and analyzing various objects in a vehicle traveling direction.

For safe automated driving, it is necessary to reliably detect various objects that become obstacles to movement such as a vehicle, a pedestrian, and a wall, and a device (signal processing device) in the vehicle 10 inputs an image captured by the camera 12, performs image analysis, and detects and analyzes various objects in a vehicle traveling direction.

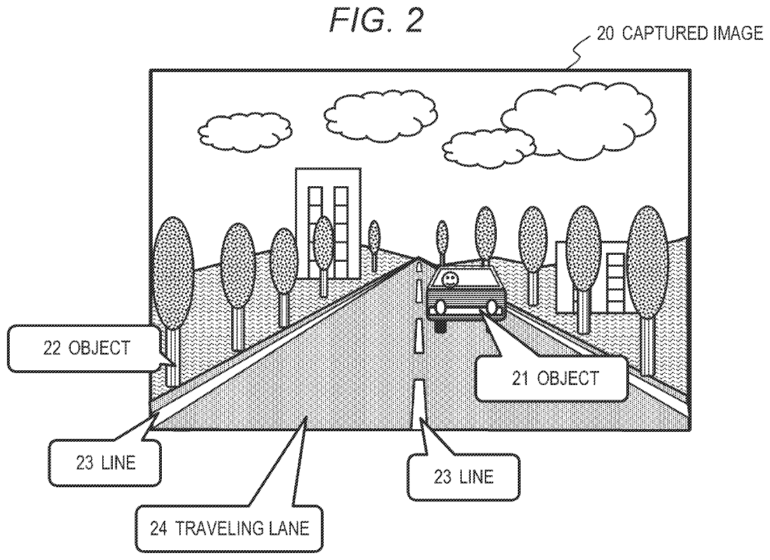

The image captured by the camera 12 is a captured image 20 as illustrated in FIG. 2, for example.

The signal processing device in the vehicle 10 analyzes the captured image 20 as illustrated in FIG. 2, for example, that is, a captured image of a vehicle traveling direction that is captured by the camera 12 of the vehicle 10, detects various objects that can be obstacles such as an oncoming vehicle and a preceding vehicle, a pedestrian, and a street tree from the captured image, and controls a traveling path and a speed of the vehicle 10 to avoid collision with these objects.

For example, in the captured image 20 illustrated in FIG. 2, an object 21 is a preceding vehicle, and an object 22 is a street tree. The signal processing device in the vehicle 10 controls a traveling path and a speed of the vehicle 10 to avoid collision with these objects.

Moreover, the signal processing device in the vehicle 10 detects a center line, a side strip, a lane boundary line, and the like on a road, recognizes a traveling lane of the vehicle 10 on the basis of these lines, and controls the vehicle 10 to travel on one traveling lane. For example, there is performed a control so that the vehicle 10 travels at a position separated by a certain distance from the lines on both sides of the traveling lane on which the vehicle 10 is traveling.

For example, in a case where the vehicle 10 is traveling on a traveling lane 24 on the left side in the captured image 20 illustrated in FIG. 2, there is performed a control for causing the vehicle 10 to travel at a position separated by a certain distance from lines 23 on both sides of the traveling lane 24.

However, in a case where the camera 12 is not a camera capable of calculating a highly accurate object distance, such as a stereo camera, but is a monocular camera, the following problem occurs in the traveling control based on an image captured by the camera.

This is a problem that a road drawn in a “drawing object” such as a photograph or a picture, which is not an actual road, is erroneously recognized as a real road.

For example, in a case where an automated vehicle enters a parking lot and a monocular camera of the vehicle captures an image of a “drawing object” such as a photograph or a picture of a road attached to a wall of the parking lot, a distance to the “drawing object” such as a photograph or a picture cannot be calculated. Therefore, there is a possibility that the road drawn in the “drawing object” is erroneously recognized as a real road. If such erroneous recognition occurs, the automated vehicle collides with a wall in an attempt to travel on the road in the photograph or the picture on the wall.

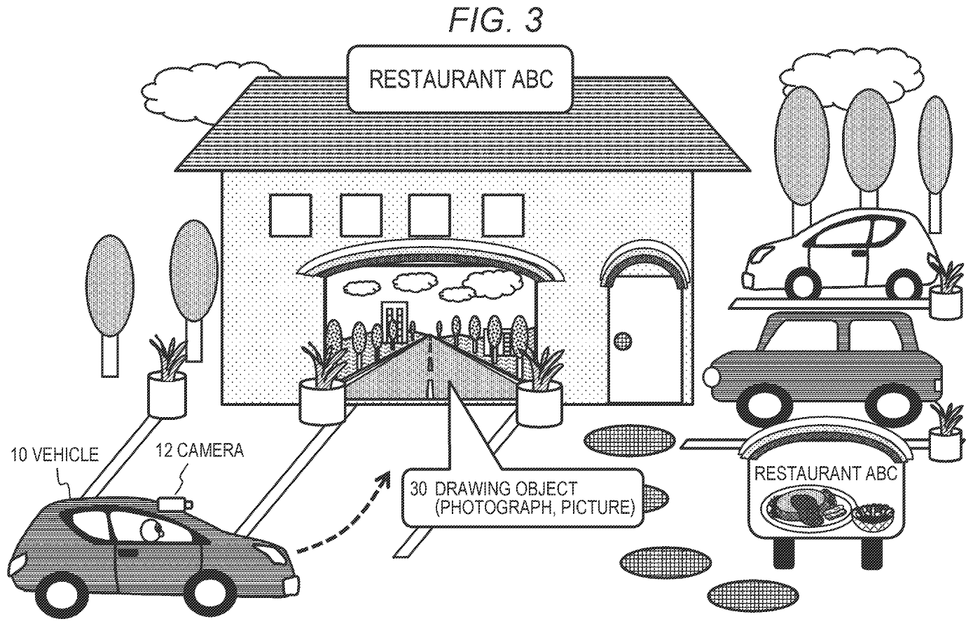

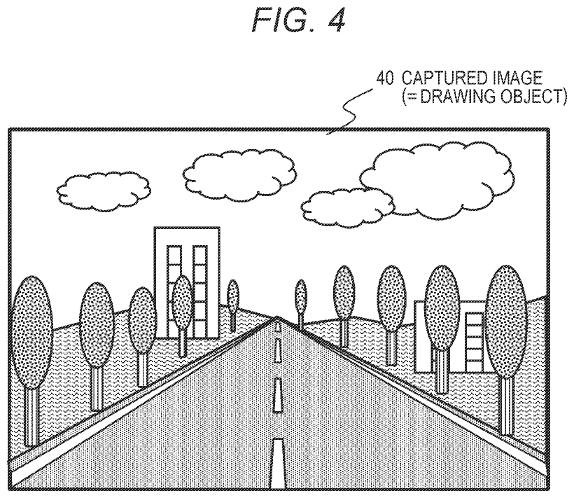

A specific example of this will be described with reference to FIG. 3 and FIG. 4.

FIG. 3 illustrates a state in which the vehicle 10 performing automated driving is entering a parking lot of a restaurant.

On a wall of the parking lot of the restaurant, a “drawing object 30” such as a photograph or a picture of a landscape including a road or the like is drawn or attached.

The camera 12 of the vehicle 10 captures an image of the “drawing object 30”. The captured image is input to the signal processing device in the vehicle 10. The signal processing device erroneously recognizes the road drawn in the “drawing object” such as a photograph or a picture as a real road. If such erroneous recognition occurs, the automated vehicle travels straight toward the wall of the restaurant and collides with the wall in an attempt to travel on the road in the photograph on the wall.

Note that an image captured by the camera 12 of the vehicle 10 at that time is a captured image 40 as illustrated in FIG. 4, for example.

The captured image 40 is a drawing object such as a photograph or a picture drawn or attached on the wall of the restaurant.

The signal processing device in the vehicle 10 may determine that the road included in the captured image 40 is an actual road, and in this case, there is a possibility of causing the vehicle 10 to travel straight toward the wall.

The present disclosure solves the above-described problem, for example.

That is, it is possible to analyze whether a road or the like in an image captured by a camera is a real object or a drawing object such as a photograph or a picture.

The following will describe the signal processing device, the signal processing method, and the program according to the present disclosure.

### [2. Regarding Specific Example of Configuration and Processing of Signal Processing Device According to Present Disclosure]

Next, specific examples of a configuration and processing of the signal processing device according to the present disclosure will be described.

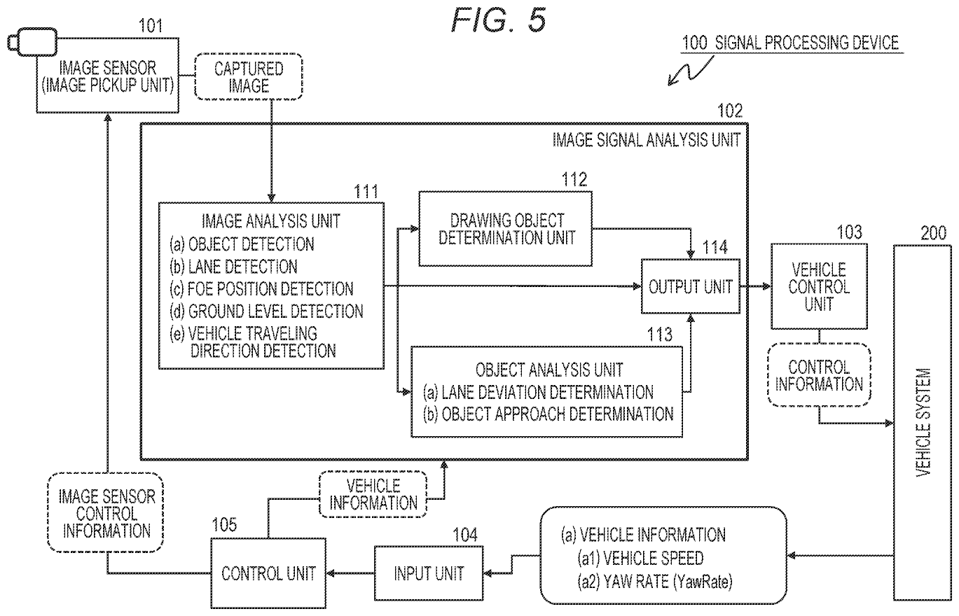

FIG. 5 is a diagram illustrating a configuration example of a signal processing device according to the present disclosure. As illustrated in FIG. 5, a signal processing device 100 includes an image sensor (image pickup unit) 101, an image signal analysis unit 102, a vehicle control unit 103, an input unit 104, and a control unit 105.

The image signal analysis unit 102 includes an image analysis unit 111, a drawing object determination unit 112, an object analysis unit 113, and an output unit 114.

The image sensor (image pickup unit) 101 is an image sensor in the camera 12 mounted on the vehicle 10 illustrated in FIG. 1, and captures an image in a traveling direction of the vehicle 10.

Note that the camera 12 used in the signal processing device 100 of the present disclosure is a monocular camera. An image captured by the image sensor (image pickup unit) 101 in the monocular camera is input to the image signal analysis unit 102.

The image signal analysis unit 102 analyzes the captured image input from the image sensor (image pickup unit) 101. For example, the types, distances, and the like of various objects included in the captured image are analyzed. For example, various objects that can be obstacles such as an oncoming vehicle, a preceding vehicle, a pedestrian, and a street tree are detected.

First, the image analysis unit 111 executes analysis processing of the captured image input from the image sensor (image pickup unit) 101. Specifically, there are executed these processing:
(a) Object detection processing
(b) Lane detection processing
(c) FOE (focus of expansion) position detection processing
(d) Ground level detection processing
(e) Vehicle traveling direction detection processing

Note that details of these processing will be described later.

The analysis result of the captured image by the image analysis unit 111 is output to the drawing object determination unit 112, the object analysis unit 113, and the output unit 114.

The drawing object determination unit 112 determines whether the object included in the image captured by the camera 12 (camera including the image sensor 101) mounted on the vehicle 10 is a real object such as an actual road or a drawing object such as a photograph or a picture on the basis of the captured image analysis result by the image analysis unit 111.

Details of this processing will be described later.

The object analysis unit 113 analyzes the types, distances, and the like of various objects included in the captured image on the basis of the captured image analysis result by the image analysis unit 111.

For example, object information including the positions, the distances (distances from the camera), the types, and the sizes of various objects that can be obstacles such as an oncoming vehicle, a preceding vehicle, a pedestrian, and a street tree, is analyzed for each object.

Specifically, for example, the processing of determining whether or not the vehicle 10 deviates from a traveling lane, and the processing of analyzing an approach state to an object that is an obstacle to traveling are performed.

Details of these processing will be described later.

The image analysis result by the image signal analysis unit 102 is output to the vehicle control unit 103 via the output unit 114. The vehicle control unit 103 outputs control information to a vehicle system 200.

The vehicle control unit 103 controls a traveling path and a speed of the vehicle to avoid collusion with the object on the basis of the image analysis result by the image signal analysis unit 102.

Vehicle information and image sensor control information obtained from the vehicle system 200 are input to the input unit 104.

The vehicle information includes a vehicle speed, change speed information (yaw rate) of a rotation angle (yaw angle) which is a change speed of a direction of the vehicle, and the like.

The image sensor control information includes control information of an image capturing direction, an angle of view, a focal length, and the like.

The vehicle information input from the input unit 104 is input to the image signal analysis unit 102 via the control unit 105. Furthermore, the image sensor control information is input to the image sensor 101 via the control unit 105, so as to adjust the image sensor 101.

As described above, the image signal analysis unit 102 analyzes the captured image input from the image sensor (image pickup unit) 101. For example, the types, distances, and the like of various objects included in the captured image are analyzed. For example, various objects that can be obstacles such as an oncoming vehicle, a preceding vehicle, a pedestrian, and a street tree are detected. Moreover, whether the object included in the captured image is an actual object or a drawing object such as a photograph or a picture is determined.

The following will sequentially describe detailed configurations and processing of each component of the image signal analysis unit 102, that is, the image analysis unit 111, the drawing object determination unit 112, and the object analysis unit 113.

### [3. Regarding Details of Configuration and Processing of Image Analysis Unit]

First, details of the configuration and processing of the image analysis unit 111 in the image signal analysis unit 102 illustrated in FIG. 5 will be described.

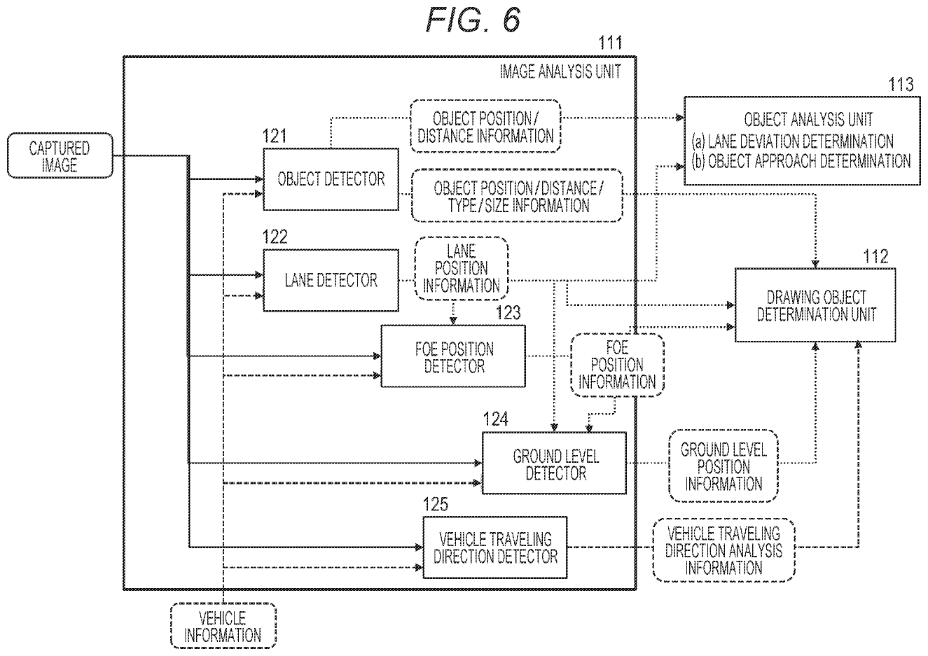

FIG. 6 illustrates the detailed configuration of the image analysis unit 111.

As illustrated in FIG. 6, the image analysis unit 111 includes an object detector 121, a lane detector 122, a FOE (focus of expansion) position detector 123, a ground level detector 124, and a vehicle traveling direction detector 125.

The object detector 121 analyzes the types, distances, and the like of various objects included in the captured image input from the image sensor (image pickup unit) 101.

For example, object information including the positions, the distances (distances from the camera), the types, and the sizes of various objects that can be obstacles such as an oncoming vehicle, a preceding vehicle, a pedestrian, and a street tree, is analyzed for each object.

The object analysis information generated by the object detector 121 is output to the drawing object determination unit 112 and the object analysis unit 113 in the image signal analysis unit 102.

The drawing object determination unit 112 inputs all of the object position information, the object distance information, the object type information, and the object size information of each object that are included in the object analysis information generated by the object detector 121.

Meanwhile, the object analysis unit 113 inputs the object position information and the object distance information of each object that are included in the object analysis information generated by the object detector 121.

The lane detector 122 analyzes the captured image input from the image sensor (image pickup unit) 101, and detects a lane on which the vehicle is traveling. The lane on which the vehicle is traveling corresponds to the traveling lane 24 described above with reference to FIG. 2

The lane detector 122 analyzes the captured image input from the image sensor (image pickup unit) 101, detects a center line, a side strip, a lane boundary line, and the like on a road, analyzes a lane position of the traveling lane of the vehicle 10 on the basis of these lines, and generates lane position information.

The lane position information generated by the lane detector 122 is output to the FOE (focus of expansion) position detector 123 and the ground level detector 124 in the image analysis unit 111, and the drawing object determination unit 112 and the object analysis unit 113 outside the image analysis unit 111.

The FOE (focus of expansion) position detector 123 analyzes the captured image input from the image sensor (image pickup unit) 101, and analyzes a FOE (focus of expansion) position in the captured image.

The FOE (focus of expansion) is a point at infinity (focus of expansion) at which parallel line segments in the real world intersect in a captured image. The focus of expansion is a point uniquely determined with respect to the optical axis of the camera.

For example, lines (a side strip, a median strip, and the like) on a straight road are parallel line segments in the real world, and a point at infinity where these lines intersect in a captured image can be detected as the FOE.

The FOE (focus of expansion) position information detected by the FOE (focus of expansion) position detector 123 is input to the ground level detector 124 and the drawing object determination unit 112.

The ground level detector 124 analyzes the captured image input from the image sensor (image pickup unit) 101, and detects a ground level (road surface position) in the captured image.

The ground level position information (road surface position information) detected by the ground level detector 124 is input to the drawing object determination unit 112.

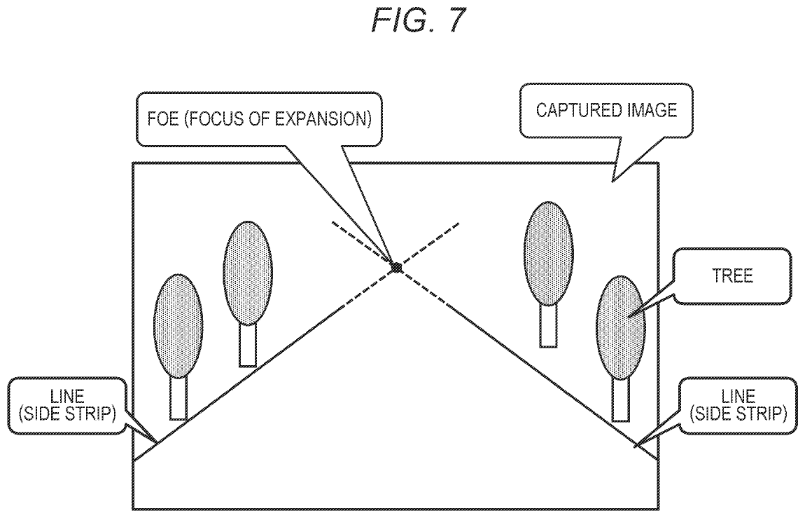

Specific examples of a FOE (focus of expansion) position detected by the FOE (focus of expansion) position detector 123 and a ground level (road surface position) detected by the ground level detector 124 will be described with reference to FIG. 7 and the subsequent drawings.

The image illustrated in FIG. 7 is a captured image input by the image analysis unit 111 from the image sensor (image pickup unit) 101.

First, the FOE (focus of expansion) position detector 123 detects a FOE (focus of expansion) position from the captured image input from the image sensor (image pickup unit) 101.

As described above, the FOE (focus of expansion) is a point at infinity (focus of expansion) at which parallel line segments in the real world intersect in a captured image.

The FOE (focus of expansion) position detector 123 detects, for example, two side strips (lines) on both sides of the road surface on which the vehicle travels as illustrated in FIG. 7, detects a point at infinity where these two side strips (lines) intersect, and sets this point as the FOE (focus of expansion) position.

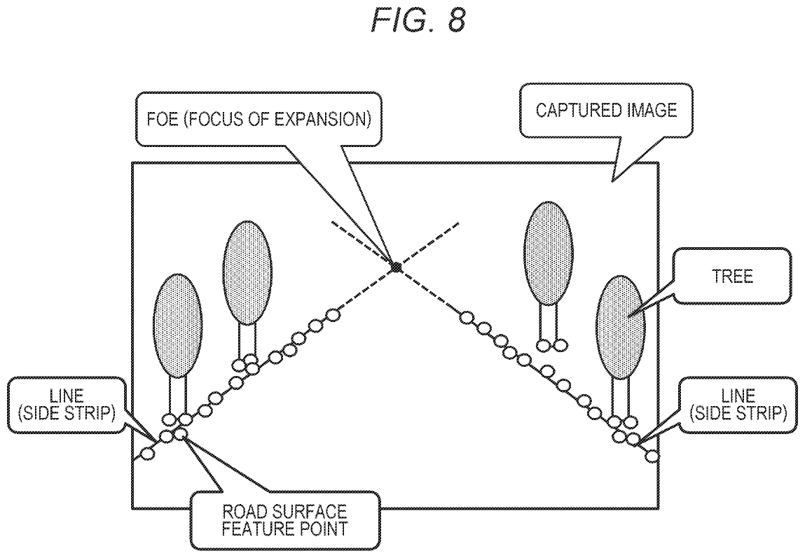

The following will describe a specific example of a ground level (road surface position) detected by the ground level detector 124 with reference to FIG. 8 and the subsequent drawings.

The image illustrated in FIG. 8 is also a captured image input by the image analysis unit 111 from the image sensor (image pickup unit) 101.

The ground level detector 124 first analyzes the captured image input from the image sensor (image pickup unit) 101, and detects feature points indicating a road surface position in the captured image. For example, two side strips (lines) and trees on both sides of the road surface on which the vehicle travels as illustrated in FIG. 8 are detected, and the positions of the two side strips (lines) and the lower end positions of the trees are detected as road surface feature points.

Next, the ground level detector 124 detects a ground level position (road surface position) at each position of the captured image using the detected road surface feature points and the FOE (focus of expansion) position information detected by the FOE (focus of expansion) position detector 123.

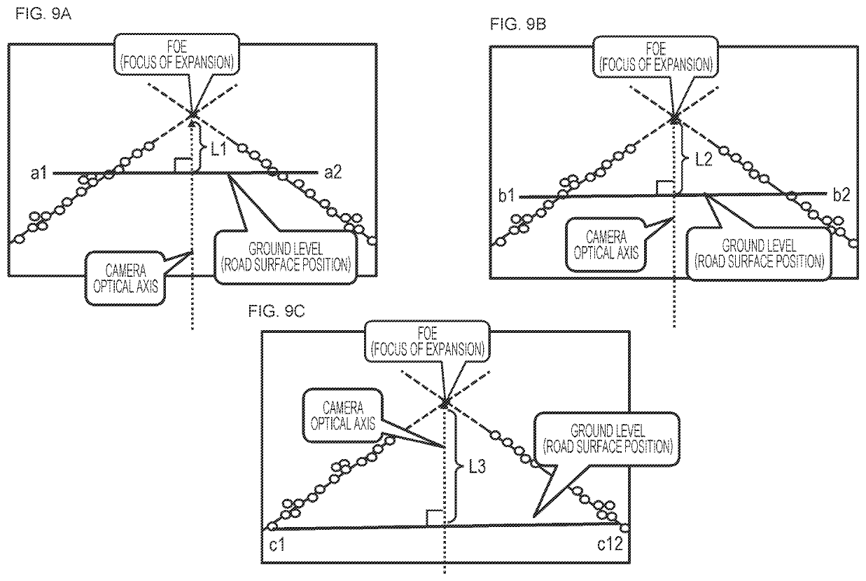

A specific example of this processing will be described with reference to FIG. 9.

FIG. 9 illustrates three diagrams of (a), (b), and (c).

Each drawing illustrates a ground level (road surface position) at a different position of the captured image.

FIG. 9 (a) illustrates a ground level (road surface position) at an image position (distance=L1) close to the FOE (focus of expansion) position detected by the FOE (focus of expansion) position detector 123.

The (b) illustrates a ground level (road surface position) at an image position (distance=L2) more separate from the FOE (focus of expansion) position than (a), and the (c) illustrates a ground level (road surface position) at an image position (distance=L3) further separate from the FOE (focus of expansion) position.

For example, the ground level (road surface position) illustrated in FIG. 9(a) is a ground level (road surface position) at an image position separate by L1 from the FOE (focus of expansion) position detected by the FOE (focus of expansion) position detector 123.

The ground level (road surface position) at the image position separate by L1 from the FOE (focus of expansion) position can be represented as a straight line that is orthogonal to the camera optical axis toward the FOE (focus of expansion) position and connects the road surface feature points at the position separate by L1 from the FOE (focus of expansion) position.

That is, the straight line a1-a2 illustrated in FIG. 9(a) is the ground level (road surface position) at the image position separate by L1 from the FOE (focus of expansion) position.

Similarly, the ground level (road surface position) illustrated in FIG. 9(b) is a ground level (road surface position) at an image position separate by L2 from the FOE (focus of expansion) position detected by the FOE (focus of expansion) position detector 123.

The ground level (road surface position) at the image position separate by L2 from the FOE (focus of expansion) position can be represented as a straight line that is orthogonal to the camera optical axis toward the FOE (focus of expansion) position and connects the road surface feature points at the position separate by L2 from the FOE (focus of expansion) position.

That is, the straight line b1-b2 illustrated in FIG. 9(b) is the ground level (road surface position) at the image position separate by L2 from the FOE (focus of expansion) position.

Similarly, the ground level (road surface position) illustrated in FIG. 9(c) is a ground level (road surface position) at an image position separate by L3 from the FOE (focus of expansion) position detected by the FOE (focus of expansion) position detector 123.

The ground level (road surface position) at the image position separate by L3 from the FOE (focus of expansion) position can be represented as a straight line that is orthogonal to the camera optical axis toward the FOE (focus of expansion) position and connects the road surface feature points at the position separate by L3 from the FOE (focus of expansion) position.

That is, the straight line c1-c2 illustrated in FIG. 9(c) is the ground level (road surface position) at the image position separate by L3 from the FOE (focus of expansion) position.

In this manner, the ground level (road surface position) at each image position in the captured image can be detected using the FOE (focus of expansion) position detected by the FOE (focus of expansion) position detector 123 and the road surface feature point position information.

In this manner, the ground level detector 124 analyzes the captured image input from the image sensor (image pickup unit) 101 to detect road surface feature points, and detects a ground level position (road surface position) at each position of the captured image using the detected road surface feature points and the FOE (focus of expansion) position information detected by the FOE (focus of expansion) position detector 123.

The ground level position (road surface position) information detected by the ground level detector 124 is input to the drawing object determination unit 112.

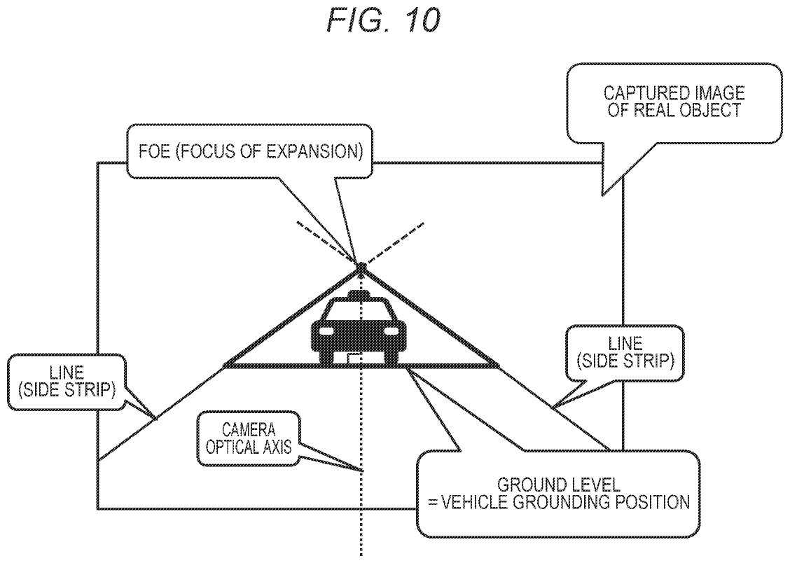

FIG. 10 is a diagram illustrating a specific example of a FOE (focus of expansion) position detected by the FOE (focus of expansion) position detector 123 and a ground level (road surface position) detected by the ground level detector 124.

These pieces of detection information are input to the drawing object determination unit 112.

The vehicle traveling direction detector 125 determines whether or not the vehicle 10 is traveling in the optical axis direction of the camera 12 mounted on the vehicle 10.

The vehicle traveling direction detector 125 determines whether or not the vehicle 10 is traveling in the optical axis direction of the camera 12 mounted on the vehicle 10 on the basis of the captured image input from the image sensor (image pickup unit) 101 and the vehicle information input from the vehicle system 200 via the input unit and the control unit 195.

The vehicle traveling direction analysis information as the determination result is input to the drawing object determination unit 112.

The processing by the drawing object determination unit 112, that is, the processing of determining whether an object in the captured image is an actual object or a drawing object such as a photograph or a picture on the basis of the image captured by the camera 12 is executed only in a case where it is confirmed that the vehicle 10 is traveling in the optical axis direction of the camera 12 mounted on the vehicle 10.

In a case where the vehicle 10 is traveling in the optical axis direction of the camera 12, it is possible to perform processing of determining whether an object in the captured image is an actual object or a drawing object such as a photograph or a picture on the basis of the image captured by the camera 12.

However, in a case where the vehicle 10 is not traveling in the optical axis direction of the camera 12, it is difficult to perform processing of determining whether an object in the captured image is an actual object or a drawing object such as a photograph or a picture on the basis of the image captured by the camera 12.

### [4. Regarding Details of Configuration and Processing of Drawing Object Determination Unit]

Next, details of the configuration and processing of the drawing object determination unit 112 in the image signal analysis unit 102 illustrated in FIG. 5 will be described.

As described above, the drawing object determination unit 112 determines whether an object included in the image captured by the camera 12 (camera including the image sensor 101) mounted on the vehicle 10 is a real object such as an actual road or a drawing object such as a photograph or a picture on the basis of the captured image analysis result by the image analysis unit 111.

Note that as described above, the determination processing by the drawing object determination unit 112 is executed only in a case where it is confirmed that the vehicle 10 is traveling in the optical axis direction of the camera 12 mounted on the vehicle 10.

As described above, in a case where the vehicle 10 is not traveling in the optical axis direction of the camera 12, it is difficult to perform processing of determining whether an object in the captured image is an actual object or a drawing object such as a photograph or a picture on the basis of the image captured by the camera 12.

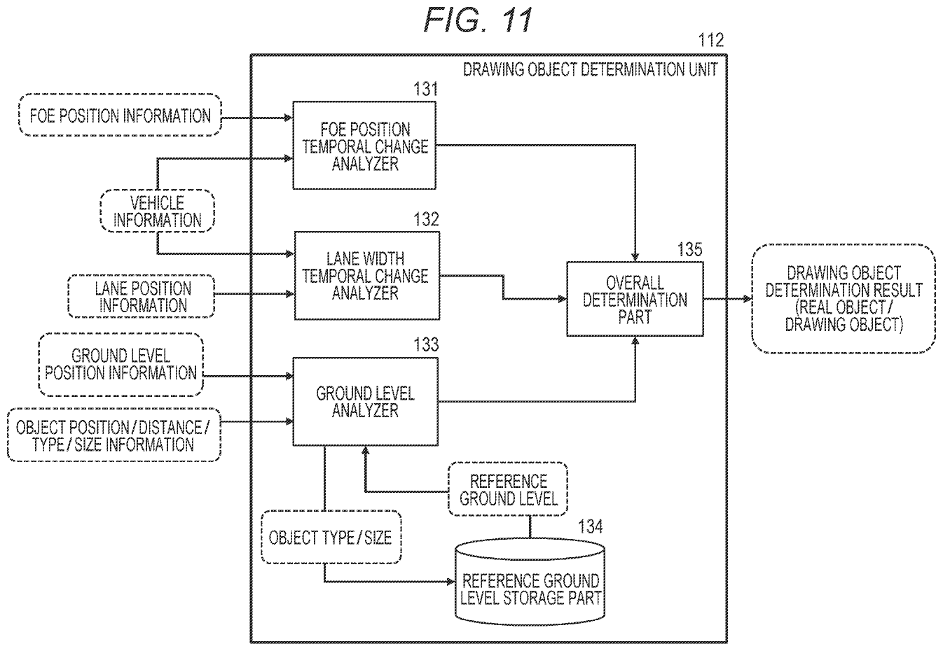

FIG. 11 is a diagram illustrating a detailed configuration of the drawing object determination unit 112.

As illustrated in FIG. 11, the drawing object determination unit 112 includes a FOE position temporal change analyzer 131, a lane width temporal change analysis 132, a ground level analyzer 133, a reference ground level storage part 134, and an overall determination part 135.

The FOE position temporal change analyzer 131 inputs each information described in the following.
(a) FOE position information detected from a captured image by the FOE position detector 123 of the image analysis unit 111
(b) Vehicle information input from the vehicle system 200 via the input unit 104 and the control unit 105

The FOE position temporal change analyzer 131 analyzes the temporal change of the FOE (focus of expansion) position in the captured image on the basis of these pieces of input information.

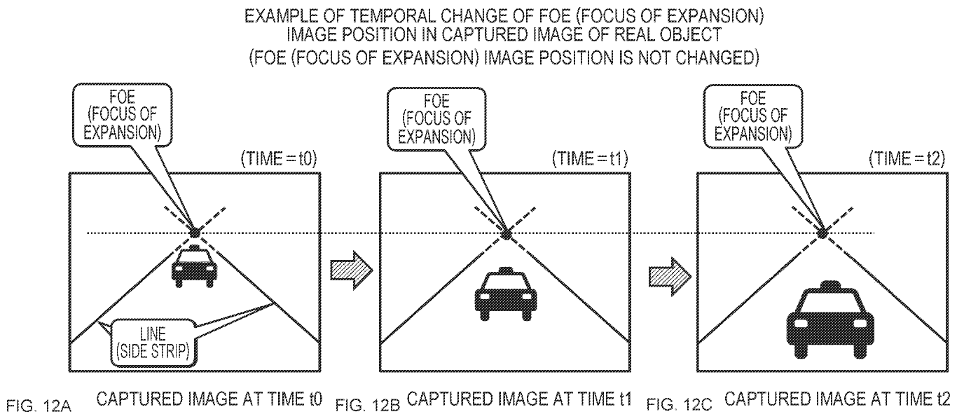

A specific example of the temporal change of the FOE (focus of expansion) position in the captured image in a case where the image captured by the camera 12 of the vehicle 10, that is, the camera 12 including the image sensor 101 is an actual road on which the vehicle 10 is traveling, that is, a real object will be described with reference to FIG. 12.

FIG. 12 illustrates examples of the captured images with the lapse of the following three times.
(a) Captured image at time t0
(b) Captured image at time t1
(c) Captured image at time t2

The time passes in the order of t0 to t1 to t2.

In the three images, images of a preceding vehicle gradually approaching with the lapse of time are captured.

The FOE (focus of expansion) position is shown in each captured image.

This FOE (focus of expansion) position is a FOE position detected from the captured image by the FOE position detector 123 of the image analysis unit 111

As described above, the FOE (focus of expansion) is a point at infinity (focus of expansion) at which parallel line segments in the real world intersect in a captured image. The focus of expansion is a point uniquely determined with respect to the optical axis of the camera.

In a case where the vehicle equipped with the camera 12 is traveling on a road with few ups and downs or curves, and the image captured by the camera 12 is a real object such as an actual road, the FOE (focus of expansion) position in the captured image is hardly changed with time transition, that is, is fixed at substantially the same position in the captured image.

As illustrated in FIG. 12, the FOE (focus of expansion) positions in the captured images at these three different times: (a) captured image at time t0, (b) captured image at time t1, and (c) captured image at time t2 are hardly changed, and are almost the same position in the captured image.

This is because the FOE (focus of expansion) is a point uniquely determined with respect to the optical axis of the camera. That is, in a case where the vehicle 10 equipped with the camera 12 is traveling in the optical axis direction of the camera 12 on a road with few ups and downs or curves, the traveling direction of the vehicle and the optical axis direction of the camera 12 are matched. Therefore, the FOE (focus of expansion) position in the captured image is hardly changed, and is substantially the same position in the captured image.

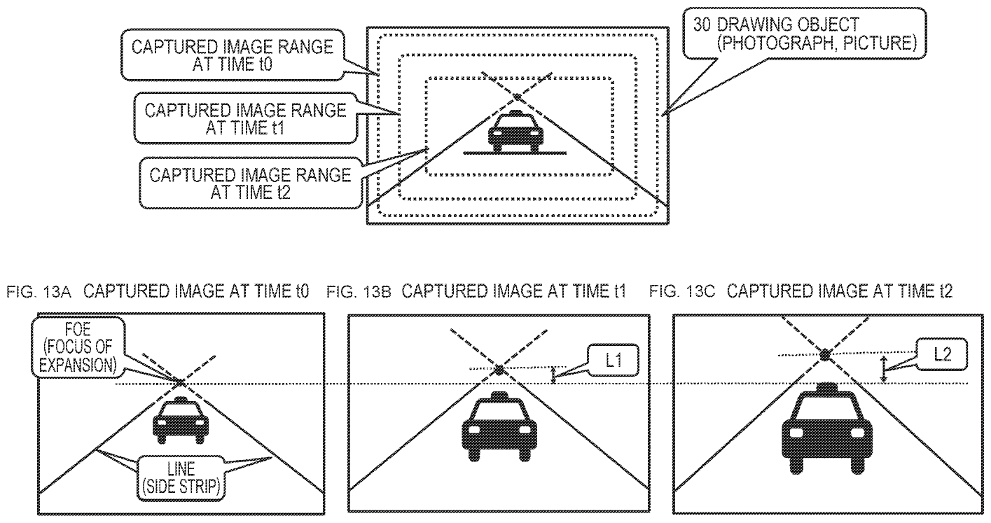

The following will describe, with reference to FIG. 13, a specific example of the temporal change of the FOE (focus of expansion) position in the captured image in a case where the image captured by the camera 12 of the vehicle 10, that is, the camera 12 including the image sensor 101 is a drawing object such as a photograph or a picture described above with reference to FIG. 3.

The upper part of FIG. 13 illustrates the drawing object 30 such as a photograph or a picture. As described above with reference to FIG. 3, the drawing object 30 is, for example, a photograph or a picture drawn on a wall of a parking lot of a restaurant. That is, a road and a vehicle in the drawing object 30 are all not real objects but drawing objects included in the photograph or the picture.

Dotted frames in the drawing object 30 in FIG. 13 indicate a temporal transition of an image range captured by the camera 12 in a case where the vehicle 10 equipped with the camera 12 approaches the drawing object 30.

For example, at time t0, the camera 12 of the vehicle 10 captures an image of the captured image range at time t0. As the vehicle 10 approaches the wall on which the drawing object 30 is drawn, the image capturing area of the camera 12 of the vehicle 10 is gradually narrowed.

That is, as illustrated in FIG. 13, at time t1, the camera 12 of the vehicle 10 captures an image of the captured image range at time t1 shown in the drawing object 30 illustrated in the upper part of FIG. 13. The captured image range at time t1 is a small area inside the captured image range at time t0.

Moreover, at time t2, the camera 12 of the vehicle 10 captures an image of the captured image range at time t2 shown in the drawing object 30 illustrated in the upper part of FIG. 13. The captured image range at time t2 is a small area further inside the captured image range at time t1.

In this manner, as the vehicle 10 approaches the wall on which the drawing object 30 is drawn, the image capturing area of the camera 12 of the vehicle 10 is gradually narrowed.

Similarly to FIG. 12, the lower part of FIG. 13 illustrates examples of the captured images with the lapse of the following three times.
(a) Captured image at time t0
(b) Captured image at time t1
(c) Captured image at time t2

The time passes in the order of t0 to t1 to t2.

The three images are captured images of the drawing object 30 illustrated in the upper part of FIG. 13. That is, they are images obtained by capturing different areas of the same drawing object 30 as follows.
(a) Captured image at time t0=captured image of captured image range at time t0 of drawing object 30 illustrated in the upper part of FIG. 13
(b) Captured image at time t1=captured image of captured image range at time t1 of drawing object 30 illustrated in the upper part of FIG. 13
(c) Captured image at time t2=captured image of captured image range at time t2 of drawing object 30 illustrated in the upper part of FIG. 13

Although the preceding vehicle appears to be gradually approaching with the lapse of time, the captured image range is simply reduced, and the size of the vehicle merely becomes larger relatively with respect to the captured image.

Also in each of the three captured images (a) to (c) in the lower part of FIG. 13, the FOE (focus of expansion) position similar to FIG. 12 described above is shown.

This FOE (focus of expansion) position is a FOE position detected from the captured image by the FOE position detector 123 of the image analysis unit 111

The FOE (focus of expansion) position shown in each of the three captured images (a) to (c) in the lower part of FIG. 13 is changed with time transition (t0->t1->t2).

In the examples of the drawing, it can be seen that the FOE (focus of expansion) position is gradually moved upward in the order of the three captured images (a) to (c) in accordance with the time transition (t0->t1->t2).

The FOE (focus of expansion) position of the “(b) captured image at time t1” is moved upward by a length [L1] from the FOE (focus of expansion) position of the “(a) captured image at time to”.

Furthermore, the FOE (focus of expansion) position of the “(c) captured image at time t2” is moved upward by a length [L2] from the FOE (focus of expansion) position of the “(a) captured image at time t0”.

Note that the example illustrated in FIG. 13 is an example of a case where the optical axis direction of the camera 12 of the vehicle 10 is toward the center position of the drawing object 30.

In a case where the optical axis direction of the camera 12 of the vehicle 10 is toward the center position of the drawing object 30, the image area captured by the camera 12 at times t0 to t3 is gradually narrowed toward the center area of the drawing object 30 in the upper part of FIG. 13. As a result, the FOE (focus of expansion) position is gradually moved upward as illustrated in the three captured images (a) to (c) in the lower part of FIG. 13.

In a case where the optical axis direction of the camera 12 of the vehicle 10 is toward a position other than the center position of the drawing object 30, the moving direction of the FOE (focus of expansion) position is a direction different from that in the example illustrated in FIG. 13.

Note that, in a case where the optical axis direction of the camera 12 of the vehicle 10 is toward the FOE (focus of expansion) position in the drawing object 30 and the vehicle 10 is also traveling straight in such a direction, the FOE (focus of expansion) position is not moved even in a case where the image captured by the camera 12 of the vehicle 10 is the drawing object 30, but the possibility of occurrence of such a coincidence is extremely low.

As described above, in a case where the camera 12 of the vehicle 10 captures an image of the drawing object 30, it is highly possible to observe that the FOE (focus of expansion) position in the captured image is moved in a certain direction with time transition.

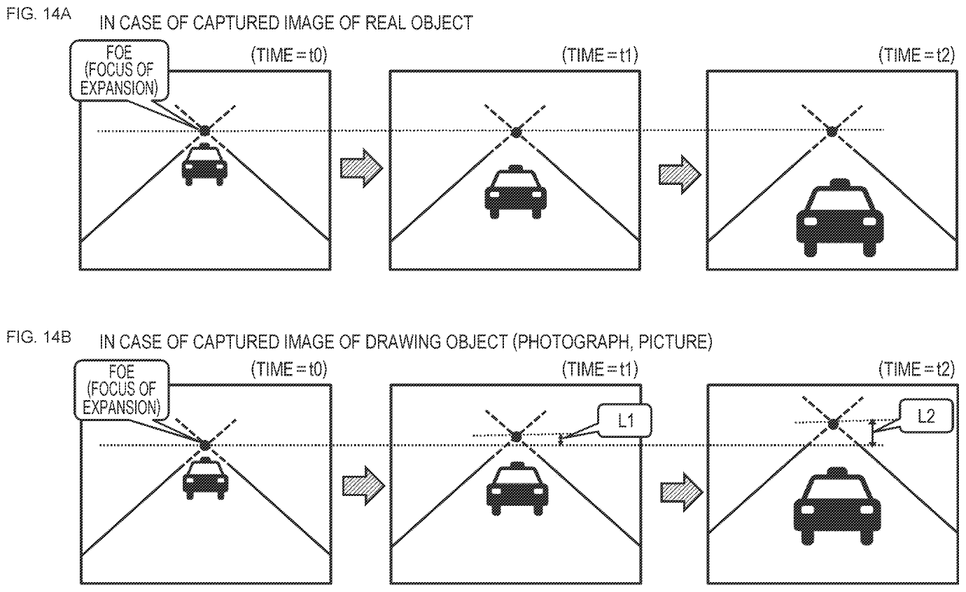

FIG. 14 is a diagram illustrating a comparison of a FOE (focus of expansion) position change state with time transition between a case where the camera 12 of the vehicle 10 captures an image of a real object including an actual road and a case where the camera 12 of the vehicle 10 captures an image of a drawing object including a road such as a photograph or a picture.

FIG. 14 illustrates the following two pieces of captured image time-series data.
(A) Example of position change with time transition of FOE (focus of expansion) in a case where a captured image is a real object
(B) Example of position change with time transition of FOE (focus of expansion) in a case where a captured image is a drawing object (photograph, picture, and the like)

In a case where the captured image is a real object as illustrated in FIG. 14(A), the FOE (focus of expansion) position in the image is not changed with time transition.

In a case where the captured image is a drawing object as illustrated in FIG. 14(B), the FOE (focus of expansion) position in the image is moved in a certain direction (in the example of the drawing, upward direction) with time transition.

In this manner, it is possible to determine whether the image captured by the camera 12 is a real object or a drawing object by detecting a change of the FOE (focus of expansion) position in the image with time transition.

As described above, the FOE position temporal change analyzer 131 of the drawing object determination unit 112 illustrated in FIG. 11 analyzes the temporal change of the FOE (focus of expansion) position in the captured image.

That is, the FOE position temporal change analyzer 131 of the drawing object determination unit 112 illustrated in FIG. 11 inputs these pieces of information:
(a) FOE position information detected from the captured image by the FOE position detector 123 of the image analysis unit 111
(b) Vehicle information input from the vehicle system 200 via the input unit 104 and the control unit 105, and
analyzes the temporal change of the FOE (focus of expansion) position in the captured image on the basis of these pieces of input information.

This analysis result is input to the overall determination part 135.

For example, the change amount data of the FOE (focus of expansion) position in the captured image per unit time is input to the overall determination part 135.

The following will describe the processing performed by the lane width temporal change analyzer 132 in the drawing object determination unit 112 illustrated in FIG. 11.

The lane width temporal change analyzer 132 of the drawing object determination unit 112 illustrated in FIG. 11 inputs each of the following information.
(a) Lane position information detected from a captured image by the lane detector 122 of the image analysis unit 111
(b) Vehicle information input from the vehicle system 200 via the input unit 104 and the control unit 105

The FOE position temporal change analyzer 131 analyzes the temporal change of the lane width of the vehicle traveling lane in the captured image on the basis of these pieces of input information.

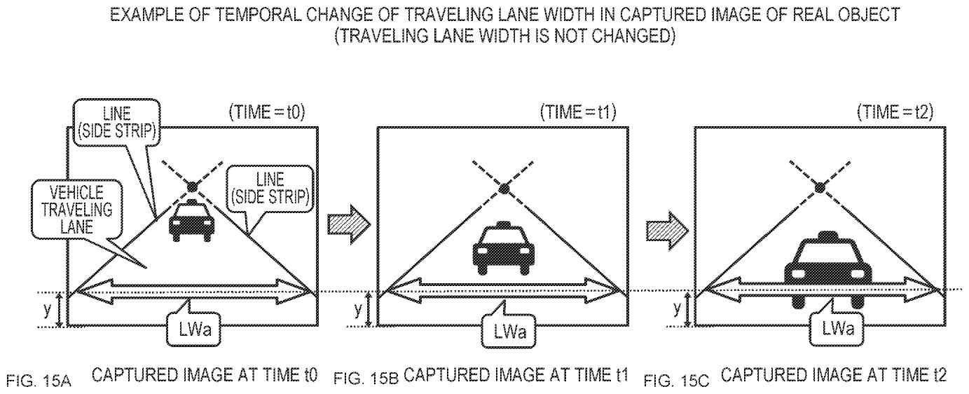

A specific example of the temporal change of the lane width of the vehicle traveling lane in the captured image in a case where the image captured by the camera 12 of the vehicle 10, that is, the camera 12 including the image sensor 101 is an actual road on which the vehicle 10 is traveling, that is, a real object will be described with reference to FIG. 15.

FIG. 15 illustrates examples of the captured images with the lapse of the following three times.
(a) Captured image at time t0
(b) Captured image at time t1
(c) Captured image at time t2

The time passes in the order of t0 to t1 to t2.

In the three images, images of a preceding vehicle gradually approaching with the lapse of time are captured.

Note that the position of the vehicle traveling lane is a lane position detected from a captured image by the lane detector 122 of the image analysis unit 111.

As described above, the lane detector 122 analyzes the captured image input from the image sensor (image pickup unit) 101, detects a center line, a side strip, a lane boundary line, and the like on a road, and analyzes a lane position of the traveling lane of the vehicle 10 on the basis of these line.

The lane width of the traveling lane of the vehicle 10 is hardly changed with time transition in many cases while traveling on the same road.

As illustrated in FIG. 15, in these captured images at three different times: (a) captured image at time t0, (b) captured image at time t1, and (c) captured image at time t2, the widths of the vehicle traveling lane, that is, the vehicle traveling lane between the lines (side strips) substantially are matched.

Note that as the measurement position of the width of the vehicle traveling lane, it is measured, for example, at the same height position in each of the captured images (a) to (c). In the examples illustrated in the drawing, the traveling lane width is measured at a position separate by y from the lower end of each image.

As illustrated in FIG. 15, the traveling lane widths at the position separate by y from the lower end of these captured images at these three different times: (a) captured image at time t0, (b) captured image at time t1, and (c) the captured image at time t2, are all LWa, and are the same lane width.

This is because, in a case where the vehicle 10 travels on a road having the same width and the FOE (focus of expansion) is substantially fixed, the road having the same width is continuously imaged at the same height position of the captured image even if the captured time is different.

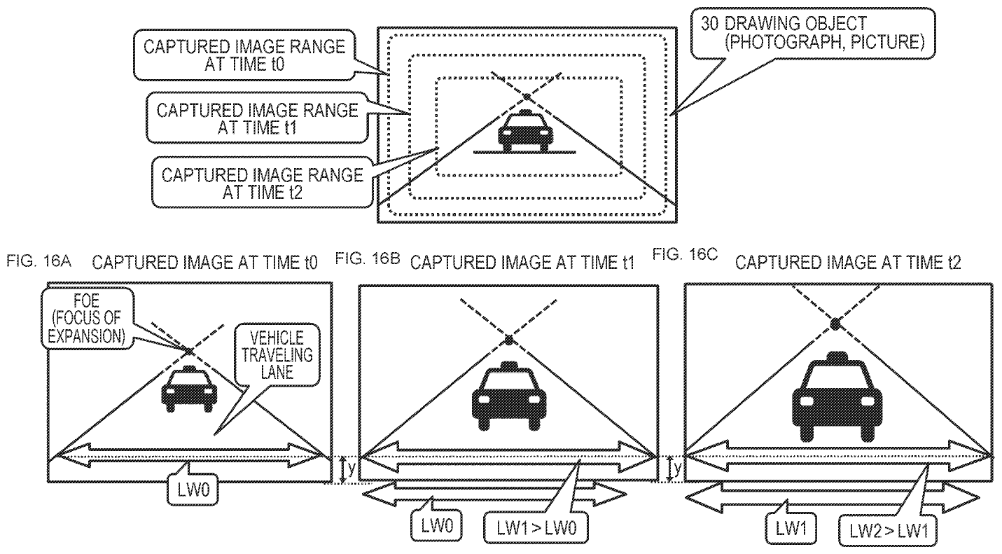

The following will describe, with reference to FIG. 16, a specific example of the temporal change of the vehicle traveling lane width in the captured image in a case where the image captured by the camera 12 of the vehicle 10, that is, the camera 12 including the image sensor 101 is a drawing object such as a photograph or a picture described above with reference to FIG. 3.

The upper part of FIG. 16 illustrates the drawing object 30 such as a photograph or a picture. As described above with reference to FIG. 3, the drawing object 30 is, for example, a photograph or a picture drawn on a wall of a parking lot of a restaurant. That is, a road and a vehicle in the drawing object 30 are all not real objects but drawing objects included in the photograph or the picture.

Dotted frames in the drawing object 30 in FIG. 16 indicate a temporal transition of an image range captured by the camera 12 in a case where the vehicle 10 equipped with the camera 12 approaches the drawing object 30.

For example, at time t0, the camera 12 of the vehicle 10 captures an image of the captured image range at time t0. As the vehicle 10 approaches the wall on which the drawing object 30 is drawn, the image capturing area of the camera 12 of the vehicle 10 is gradually narrowed.

That is, as illustrated in FIG. 16, at time t1, the camera 12 of the vehicle 10 captures an image of the captured image range at time t1 in the drawing object 30 illustrated in the upper part of FIG. 16. The captured image range at time t1 is a small area inside the captured image range at time t0.

Moreover, at time t2, the camera 12 of the vehicle 10 captures an image of the captured image range at time t2 in the drawing object 30 illustrated in the upper part of FIG. 16. The captured image range at time t2 is a small area further inside the captured image range at time t1.

In this manner, as the vehicle 10 approaches the wall on which the drawing object 30 is drawn, the image capturing area of the camera 12 of the vehicle 10 is gradually narrowed.

Similarly to FIG. 15, the lower part of FIG. 16 illustrates examples of the captured images with the lapse of the following three times.
(a) Captured image at time t0
(b) Captured image at time t1
(c) Captured image at time t2

The time passes in the order of t0 to t1 to t2.

The three images are captured images of the drawing object 30 illustrated in the upper part of FIG. 16. That is, they are images obtained by capturing different areas of the same drawing object 30 as follows.
(a) Captured image at time t0=captured image of captured image range at time t0 of drawing object 30 illustrated in the upper part of FIG. 16
(b) Captured image at time t1=captured image of captured image range at time t1 of drawing object 30 illustrated in the upper part of FIG. 16
(c) Captured image at time t2=captured image of captured image range at time t2 of drawing object 30 illustrated in the upper part of FIG. 16

Although the preceding vehicle appears to be gradually approaching with the lapse of time, the captured image range is simply reduced, and the size of the vehicle merely becomes larger relatively with respect to the captured image.

Also in each of the three captured images (a) to (c) in the lower part of FIG. 16, the traveling lane width at a position separate by y from the lower end of the image is shown, similarly to FIG. 15 described above.

The position of the traveling lane is a FOE position detected from a captured image by the lane detector 122 of the image analysis unit 111.

The traveling lane width of the position separate by y from the lower end of each image shown in each of the three captured images (a) to (c) in the lower part of FIG. 16 is changed with time transition (t0->t1->t2).

In the example of the drawing, it can be seen that the traveling lane width gradually becomes larger in the order of the three captured images (a) to (c) in accordance with the time transition (t0->t1->t2).

The traveling lane width of “(a) captured image at time t0” is LW0,
the traveling lane width of “(b) captured image at time t1” is LW1, and
the traveling lane width of “(a) captured image at time t2” is LW2, and
the traveling lane width gradually becomes larger in this manner:

LW0<LW1<LW2.

As described above, in a case where the camera 12 of the vehicle 10 captures an image of the drawing object 30, the traveling lane width of the vehicle in the captured image is observed while being changed with time transition.

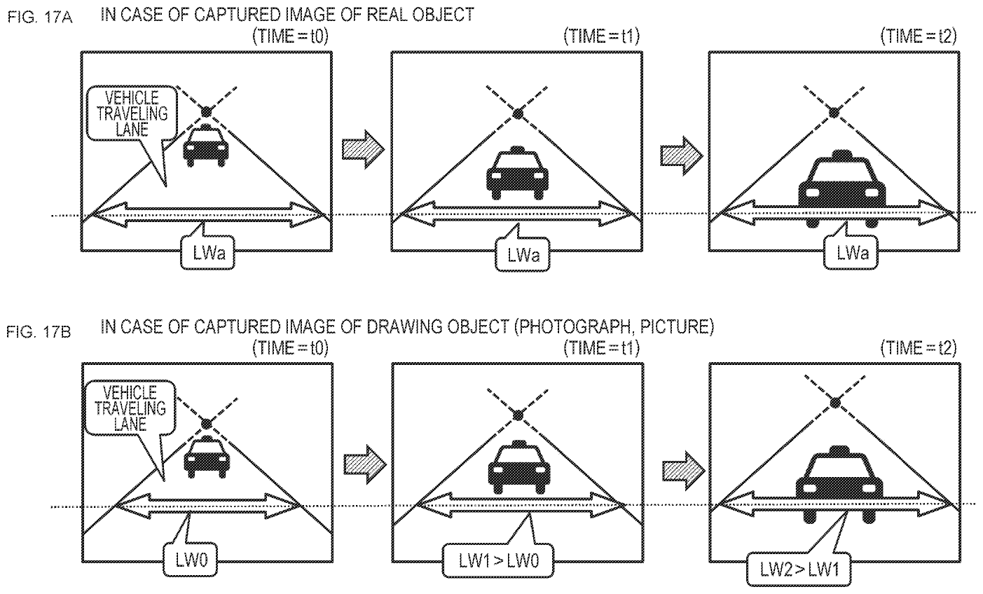

FIG. 17 is a diagram illustrating a comparison of a vehicle traveling lane lane width change state with time transition between a case where the camera 12 of the vehicle 10 captures an image of a real object including an actual road and a case where the camera 12 of the vehicle 10 captures an image of a drawing object including a road such as a photograph or a picture.

FIG. 17 illustrates the following two pieces of captured image time-series data.
(A) Example of lane width change with time transition of vehicle traveling lane in a case where a captured image is a real object
(B) Example of lane width change with time transition of vehicle traveling lane in a case where a captured image is a drawing object (photograph, picture, and the like)

In a case where the captured image is a real object as illustrated in FIG. 17(A), the lane width of the vehicle traveling lane is not changed with time transition.

In a case where the captured image is a drawing object as illustrated in FIG. 17(B), the lane width of the vehicle traveling lane is changed with time transition.

In this manner, it is possible to estimate whether the image captured by the camera 12 is a real object or a drawing object by detecting the presence/absence of a change of the lane width of the vehicle traveling lane with time transition.

As described above, the lane width temporal change analyzer 132 of the drawing object determination unit 112 illustrated in FIG. 11 analyzes the temporal change of the lane width of the vehicle traveling lane in the captured image.

That is, the lane width temporal change analyzer 132 of the drawing object determination unit 112 illustrated in FIG. 11 inputs these pieces of information:
(a) Lane position information detected from the captured image by the lane position detector 122 of the image analysis unit 111
(b) Vehicle information input from the vehicle system 200 via the input unit 104 and the control unit 105, and
analyzes the temporal change of the lane width of the vehicle traveling lane in the captured image on the basis of these pieces of input information.

This analysis result is input to the overall determination part 135.

For example, the change amount data of the lane width of the vehicle traveling lane in the captured image per unit time is input to the overall determination part 135.

The following will describe the details of the processing performed by the ground level analyzer 133 of the drawing object determination unit 112 illustrated in FIG. 11.

The ground level analyzer 133 inputs each of the following information.
(a) Ground level position information detected from a captured image by the ground level detector 124 of the image analysis unit 111
(b) Object information (object position, distance, type, size) of the object detected from a captured image by the object detector 121 of the image analysis unit 111

On the basis of these pieces of input information, the ground level analyzer 133 analyzes whether or not the ground level in the captured image is detected from a correct position, specifically, whether or not the ground level matches the grounding position of the grounding object included in the captured image.

Specifically, for example, the ground level position corresponding to the grounding position of the grounding object (vehicle or the like) is estimated from the size of the grounding object such as a vehicle in the captured image.

Moreover, a difference between the estimated grant level position and the grounding position (tire lower end position) of the grounding object such as a vehicle is calculated so as to determine whether or not the difference is equal to or larger than a predetermined threshold value.

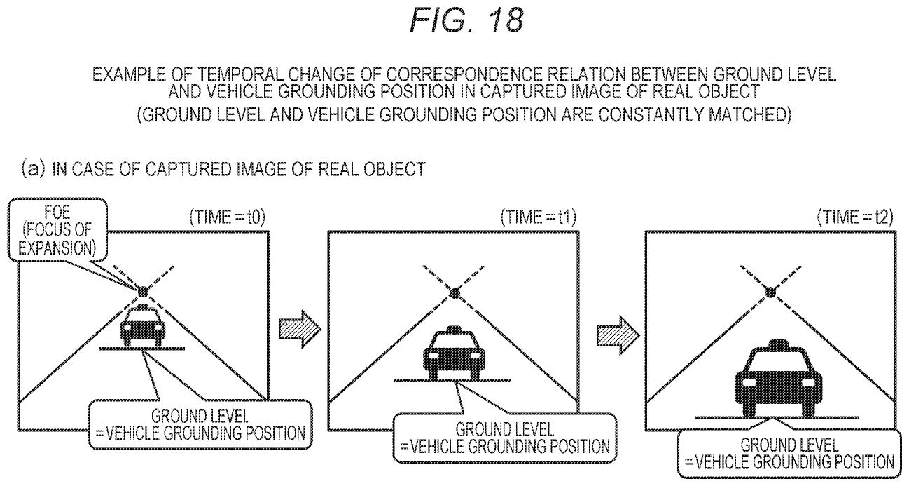

A specific example of the relation between the ground level detected from the captured image and the grounding position of the vehicle in the captured image, in a case where the image captured by the camera 12 of the vehicle 10, that is, the camera 12 including the image sensor 101 is an actual road on which the vehicle 10 is traveling, that is, a real object, will be described with reference to FIG. 18.

FIG. 18 illustrates examples of the captured images with the lapse of the following three times.
(a) Captured image at time t0
(b) Captured image at time t1
(c) Captured image at time t2

The time passes in the order of t0 to t1 to t2.

In the three images, images of a preceding vehicle gradually approaching with the lapse of time are captured.

In each captured image, a ground level is shown.

The ground level is a ground level detected from a captured image by the ground level detector 124 of the image analysis unit 111.

As described above with reference to FIG. 8 and FIG. 9, the ground level detector 124 first analyzes the captured image input from the image sensor (image pickup unit) 101, and detects feature points indicating a road surface position in the captured image.

For example, two side strips (lines) and trees on both sides of the road surface on which the vehicle travels as illustrated in FIG. 8 are detected, and the positions of the two side strips (lines) and the lower end positions of the trees are detected as road surface feature points.

Moreover, as described with reference to FIG. 9, the ground level detector 124 estimates a ground level (road surface position) at an image position separate by Lx from the FOE (focus of expansion) position in the following manner.

That is, a straight line that is orthogonal to the camera optical axis toward the FOE (focus of expansion) position and connects the road surface feature points at the position separate by Lx from the FOE (focus of expansion) position is estimated to be a ground level position.

As illustrated in FIG. 18, in the captured images at these three different times: (a) captured image at time t0, (b) captured image at time t1, and (c) captured image at time t2, the position of the ground level detected by the ground level detector 124 of the image analysis unit 111 matches the grounding position of the vehicle (real object) which is a subject of the captured image.

Note that the ground level is set to a different position for each distance Lx from the FOE (focus of expansion) position, as described above with reference to FIG. 8 and FIG. 9.

The ground level detector 124 estimates a ground level position corresponding to the grounding position of the grounding object (vehicle or the like) on the basis of the size of the grounding object included in the captured image, in this example, the grounding object (vehicle) such as a preceding vehicle or an oncoming vehicle.

The reference ground level indicating the estimated grounding position of the grounding object (vehicle or the like) corresponding to the type and size of the grounding object (vehicle or the like) is stored in the reference ground level storage part 134.

On the basis of the size of the grounding object included in the captured image, in this example, the grounding object (vehicle) such as a preceding vehicle or an oncoming vehicle, the ground level detector 124 acquires a reference ground level indicating an estimated grounding position of the grounding object (vehicle or the like) corresponding to the type and size of the grounding object (vehicle or the like) from the reference ground level storage part 134.

The reference ground level position obtained as the result is a ground level position illustrated in FIG. 18.

In these captured images at three different times: (a) captured image at time t0, (b) captured image at time t1, and (c) captured image at time t2, the position of the reference ground level obtained by the ground level detector 124 of the image analysis unit 111 matches the grounding position of the vehicle (real object) which is a subject of the captured image.

This is a natural result. That is, the vehicle traveling on a vehicle traveling lane travels while the tires are in contact with the position of the ground level (road surface position), and the position of the ground level matches the grounding position of the vehicle (real object) which is a subject of the captured image.

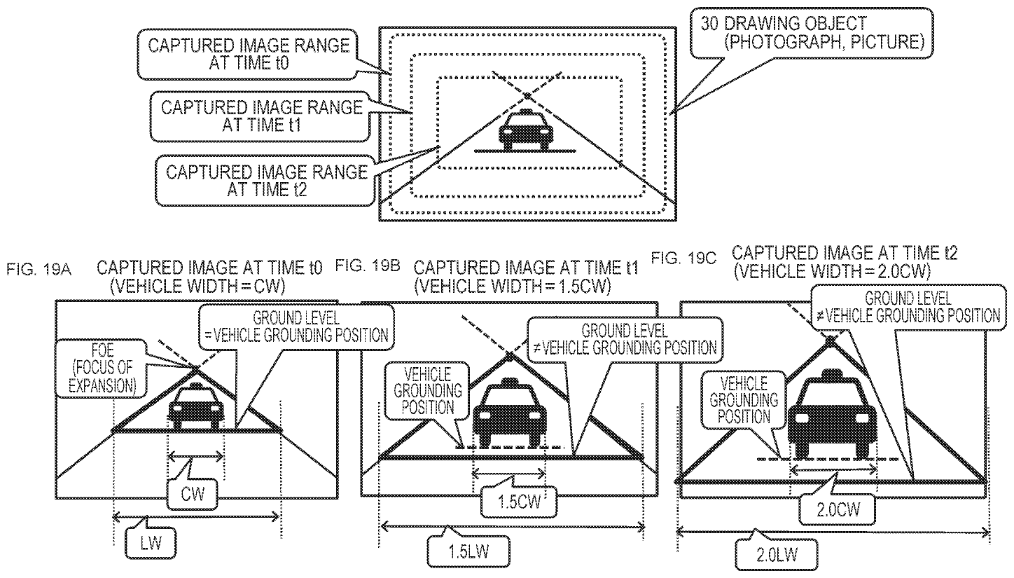

The following will describe, with reference to FIG. 19, a specific example of the relation between the ground level detected from the captured image in a case where the image captured by the camera 12 of the vehicle 10, that is, the camera 12 including the image sensor 101 is a drawing object such as a photograph or a picture described above with reference to FIG. 3.

The upper part of FIG. 19 illustrates the drawing object 30 such as a photograph or a picture. As described above with reference to FIG. 3, the drawing object 30 is, for example, a photograph or a picture drawn on a wall of a parking lot of a restaurant. That is, a road and a vehicle in the drawing object 30 are all not real objects but drawing objects included in the photograph or the picture.

Dotted frames in the drawing object 30 in FIG. 19 indicate a temporal transition of an image range captured by the camera 12 in a case where the vehicle 10 equipped with the camera 12 approaches the drawing object 30.

For example, at time t0, the camera 12 of the vehicle 10 captures an image of the captured image range at time t0. As the vehicle 10 approaches the wall on which the drawing object 30 is drawn, the image capturing area of the camera 12 of the vehicle 10 is gradually narrowed.

That is, as illustrated in FIG. 19, at time t1, the camera 12 of the vehicle 10 captures an image of the captured image range at time t1 in the drawing object 30 illustrated in the upper part of FIG. 19. The captured image range at time t1 is a small area inside the captured image range at time t0.

Moreover, at time t2, the camera 12 of the vehicle 10 captures an image of the captured image range at time t2 in the drawing object 30 illustrated in the upper part of FIG. 19. The captured image range at time t2 is a small area further inside the captured image range at time t1.

In this manner, as the vehicle 10 approaches the wall on which the drawing object 30 is drawn, the image capturing area of the camera 12 of the vehicle 10 is gradually narrowed.

Similarly to FIG. 18, the lower part of FIG. 19 illustrates examples of the captured images with the lapse of the following three times.
(a) Captured image at time t0
(b) Captured image at time t1
(c) Captured image at time t2

The time passes in the order of t0 to t1 to t2.

The three images are captured images of the drawing object 30 illustrated in the upper part of FIG. 19. That is, they are images obtained by capturing different areas of the same drawing object 30 as follows.
(a) Captured image at time t0=captured image of captured image range at time t0 of drawing object 30 illustrated in the upper part of FIG. 19
(b) Captured image at time t1=captured image of captured image range at time t1 of drawing object 30 illustrated in the upper part of FIG. 19
(c) Captured image at time t2=captured image of captured image range at time t2 of drawing object 30 illustrated in the upper part of FIG. 19

Although the preceding vehicle appears to be gradually approaching with the lapse of time, the captured image range is simply reduced, and the size of the vehicle merely becomes larger relatively with respect to the captured image.

Also in each of the three captured images (a) to (c) in the lower part of FIG. 19, the ground level position is illustrated, similarly to FIG. 18 described above.

The ground level is a ground level detected by the ground level detector 124 of the image analysis unit 111 illustrated in FIG. 6.

Note that the ground level is set to a different position for each distance Lx from the FOE (focus of expansion) position, as described above with reference to FIG. 8 and FIG. 9.

As described above, the ground level detector 124 estimates a ground level position corresponding to the grounding position of the grounding object (vehicle or the like) on the basis of the size of the grounding object included in the captured image, in this example, the grounding object (vehicle) such as a preceding vehicle or an oncoming vehicle.

The reference ground level indicating the estimated grounding position of the grounding object (vehicle or the like) corresponding to the type and size of the grounding object (vehicle or the like) is stored in the reference ground level storage part 134.

On the basis of the size of the grounding object included in the captured image, in this example, the grounding object (vehicle) such as a preceding vehicle or an oncoming vehicle, the ground level detector 124 acquires a reference ground level indicating an estimated grounding position of the grounding object (vehicle or the like) corresponding to the type and size of the grounding object (vehicle or the like) from the reference ground level storage part 134.

The reference ground level position obtained as the result is a ground level position illustrated in FIG. 19.

In (a) captured image at time t0, the position of the reference ground level obtained by the ground level detector 124 of the image analysis unit 111 matches the grounding position of the vehicle (real object) which is a subject of the captured image.

However, in the captured images at these times: (b) captured image at time t1, and (c) captured image at time t2, the position of the reference ground level obtained by the ground level detector 124 of the image analysis unit 111 does not match the grounding position of the vehicle (real object) which is a subject of the captured image.

This is because the captured image is not a captured image of a real object such as an actual road but a captured image of a drawing object such as a photograph or a picture.

As described above, in a case where the camera 12 of the vehicle 10 captures the drawing object 30, there occurs a phenomenon in which the grounding position of the grounding object (vehicle or the like) in the captured image does not match the position of the grant level estimated on the basis of the size change of the grounding object (vehicle or the like).

Note that, in the above-described processing example, there has been described the example in which the ground level detector 124 acquires a reference ground level indicating the estimated grounding position corresponding to the type and size of the grounding object (vehicle or the like); however, a configuration not using such data stored in the reference ground level storage part 134 is also possible.

That is, the ground level detector 124 may perform processing of estimating (calculating) the position of the ground level to be the grounding position on the basis of the size of the grounding object (vehicle) included in the captured image.

For example, the following processing is executed.

The ground level detector 124 estimates a ground level position corresponding to the grounding position of the grounding object (vehicle or the like) on the basis of the size of the grounding object included in the captured image, in this example, the grounding object (vehicle) such as a preceding vehicle or an oncoming vehicle.

First, in “(a) Captured image at time t0” in the lower part of FIG. 19, the ground level analyzer 133 of the drawing object determination unit 112 sets a ground level at the grounding position of the vehicle which is a subject of the captured image.

The ground level analyzer 133 calculates the vehicle size (vehicle width) and the width between lines (side strips) at the ground level position in “(a) Captured image at time t0” in the lower part of FIG. 19. Each width data is as follows:

Vehicle size (vehicle width)=CW

Width between lines (side strips) at ground level position=LW

Next, the ground level analyzer 133 calculates a vehicle size (vehicle width) from “(b) Captured image at time t1” in the lower part of FIG. 19. The vehicle width data are as follows:

Vehicle size (vehicle width)=1.5CW

That is, the vehicle size (vehicle width) of “(b) Captured image at time t1” is calculated to be 1.5 times the vehicle size (vehicle width) of “(a) Captured image at time t0”.

On the basis of this magnification (1.5 times), the ground level analyzer 133 estimates that the width between lines (side strips) at the ground level position of “(b) Captured image at time t1” is also the same magnification ratio (1.5 times, 1.5 LW), and obtains a ground level position where the setting of such a width between lines (side strips) is possible.

As a result, the ground level setting position indicated in “(b) Captured image at time t1” in the lower part of FIG. 19 is detected.

The ground level indicated in “(b) Captured image at time t1” in the lower part of FIG. 19 is:

Width between lines (side strips) at ground level position=1.5LW

That is, the vehicle size (vehicle width) in “(b) Captured image at time t1” and the width between lines (side strips) at the ground level position in the lower part of FIG. 19 are the following each width data:

Vehicle size (vehicle width)=1.5CW

Width between lines (side strips) at ground level position=1.5LW

In this manner, the ground level analyzer 133 may perform processing of estimating (calculating) the position of the ground level to be the grounding position on the basis of the size of the grounding object (vehicle) included in the captured image without using the data stored in the reference ground level storage part 134.

In a case where the captured image is a real image, if the vehicle size (vehicle width) of the captured image at time t0 and the width between lines (side strips) at the ground level position are enlarged at the same magnification ratio, the ground level position and the vehicle grounding position are matched.

However, in “(b) Captured image at time t1” in the lower part of FIG. 19, the ground level position and the vehicle grounding position are not matched.

This is because the captured image is not a captured image of a real object such as an actual road but a captured image of a drawing object such as a photograph or a picture.

Similarly, the ground level analyzer 133 calculates a vehicle size (vehicle width) from “(c) Captured image at time t2” in the lower part of FIG. 19. The vehicle width data are as follows:

Vehicle size (vehicle width)=2.0CW

That is, the vehicle size (vehicle width) of “(c) Captured image at time t2” is calculated to be 2.0 times the vehicle size (vehicle width) of “(a) Captured image at time t0”.

On the basis of this magnification (2.0 times), the ground level analyzer 133 estimates that the width between lines (side strips) at the ground level position of “(c) Captured image at time t2” is also the same magnification ratio (2.0 times, 2.0LW), and obtains a ground level position where the setting of such a width between lines (side strips) is possible.

As a result, the ground level setting position indicated in “(c) Captured image at time t2” in the lower part of FIG. 19 is detected.

The ground level indicated in “(c) Captured image at time t2” in the lower part of FIG. 19 is:

Width between lines (side strips) at ground level position=2.0LW

That is, the vehicle size (vehicle width) in “(c) Captured image at time t2” and the width between lines (side strips) at the ground level position in the lower part of FIG. 19 are the following each width data:

Vehicle size (vehicle width)=2.0CW

Width between lines (side strips) at ground level position=2.0LW

In this manner, the ground level analyzer 133 is able to perform processing of estimating (calculating) the position of the ground level to be the grounding position on the basis of the size of the grounding object (vehicle) included in the captured image without using the data stored in the reference ground level storage part 134.

In a case where the captured image is a real image, if the vehicle size (vehicle width) of the captured image at time t0 and the width between lines (side strips) at the ground level position are enlarged at the same magnification ratio, the ground level position and the vehicle grounding position are matched.

However, in “(c) Captured image at time t2” in the lower part of FIG. 19, the ground level position and the vehicle grounding position are not matched.

This is because the captured image is not a captured image of a real object such as an actual road but a captured image of a drawing object such as a photograph or a picture.

As described above, in a case where the camera 12 of the vehicle 10 captures the drawing object 30, there is occurred a phenomenon in which the grounding position of the grounding object (vehicle or the like) in the captured image does not match the position of the grant level estimated on the basis of the size change of the grounding object (vehicle or the like).

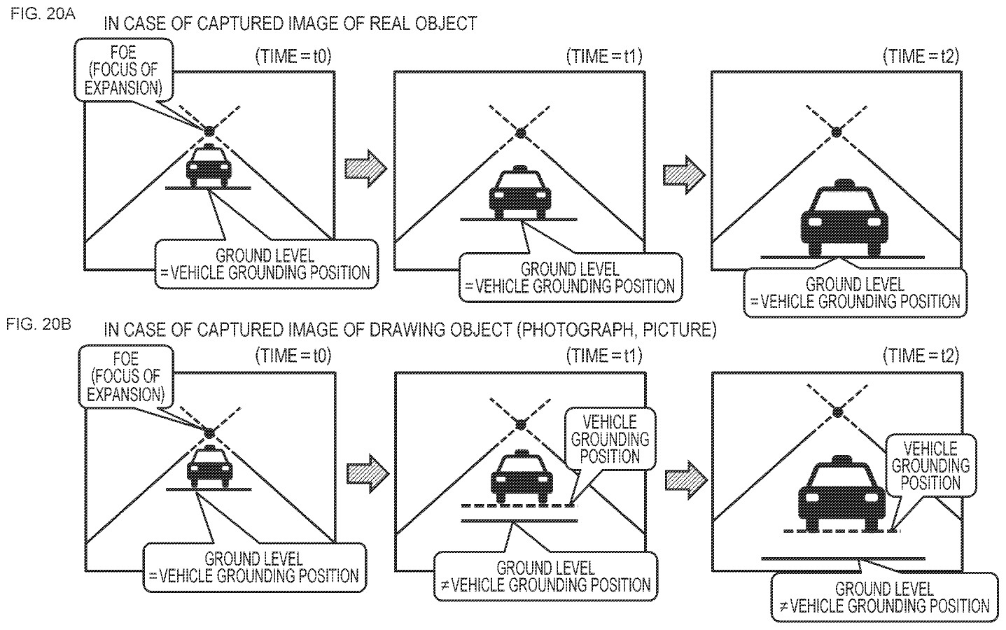

FIG. 20 is a diagram illustrating a comparison of correspondence relation change of a ground level and a vehicle grounding position with time transition between a case where the camera 12 of the vehicle 10 captures an image of a real object including an actual road and a case where the camera 12 of the vehicle 10 captures an image of a drawing object including a road such as a photograph or a picture.

FIG. 20 illustrates the following two pieces of captured image time-series data.
(A) Example of correspondence relation change with time transition between ground level and vehicle grounding position in a case where a captured image is a real object
(B) Example of correspondence relation change with time transition between ground level and vehicle grounding position in a case where a captured image is a drawing object (photograph, picture, and the like)

In a case where the captured image illustrated in FIG. 20(A) is a real object, positional deviation does not occur between the ground level and the vehicle grounding position even with time transition, and the relation of ground level=vehicle grounding position is constantly maintained.

Meanwhile, in a case where the captured image illustrated in FIG. 20(B) is a drawing object, positional deviation occurs between the ground level and the vehicle grounding position with time transition, and the relation of ground level=vehicle grounding position is not maintained.

That is, the vehicle is in a floating state at a position higher than the ground level.

In this manner, it is possible to estimate whether the image captured by the camera 12 is a real object or a drawing object by detecting whether the ground level position matches or does not match the grounding position of the real object (vehicle or the like).

As described above, the ground level analyzer 133 of the drawing object determination unit 112 illustrated in FIG. 11 analyzes whether or not the ground level in the captured image is detected from a correct position, specifically, whether or not the ground level matches the grounding position of the grounding object included in the captured image.

That is, first, the ground level position corresponding to the grounding position of the grounding object (vehicle or the like) is estimated from the size of the grounding object such as a vehicle in the image captured by the camera 12 mounted on the vehicle 10.

Moreover, a difference between the estimated grant level position corresponding to the grounding object (vehicle or the like) and the grounding position (tire lower end position) of the grounding object such as the vehicle is calculated so as to determine whether or not the difference is equal to or larger than a predetermined threshold value.

In this manner, on the basis of these pieces of input information:
(a) Ground level position information detected from a captured image by the ground level detector 124 of the image analysis unit 111
(b) Object information (object position, distance, type, size) of the object detected from a captured image by the object detector 121 of the image analysis unit 111,
the ground level analyzer 133 of the drawing object determination unit 112 illustrated in FIG. 11 determines whether or not the ground level in the captured image is detected from a correct position.

Specifically, the ground level position corresponding to the grounding position of the grounding object (vehicle or the like) is estimated from the size of the grounding object such as a vehicle in the image captured by the camera so as to calculate a difference between the estimated grant level position corresponding to the grounding object (vehicle or the like) and the grounding position (tire lower end position) of the grounding object such as a vehicle, and the difference analysis result is input to the overall determination part 135.

The following will describe the processing performed by the overall determination part 135 of the drawing object determination unit 112 illustrated in FIG. 11.

The overall determination part 135 of the drawing object determination unit 112 inputs each of the following data.
(a) Temporal change data of the FOE (focus of expansion) position in the captured image analyzed by the FOE position temporal change analyzer 131, for example, a change amount per unit time of the FOE (focus of expansion) position in the captured image
(b) Temporal change data of the lane width of the vehicle traveling lane in the captured image analyzed by the lane width temporal change analyzer 132, for example, a change amount per unit time of the lane width of the vehicle traveling lane in the captured image
(c) Difference data between the grant level position corresponding to the grounding object (vehicle or the like) in the captured image analyzed by the ground level analyzer 133 and the grounding position (tire lower end position) of the grounding object such as a vehicle

On the basis of these pieces of input data, the overall determination part 135 of the drawing object determination unit 112 illustrated in FIG. 11 determines whether the image captured by the camera 12 (camera including the image sensor 101) mounted on the vehicle 10 is a real object such as an actual road or a drawing object such as a photograph or a picture drawn on a wall or the like.

Specifically, the following determination result is output.
(a) The image captured by the camera 12 is determined to be a drawing object in a case where the temporal change data of the FOE (focus of expansion) position in the captured image analyzed by the FOE position temporal change analyzer 131, for example, a change amount per unit time of the FOE (focus of expansion) position in the captured image is equal to or larger than a predetermined threshold value.

Moreover,
(b) The image captured by the camera 12 is determined to be a drawing object in a case where the temporal change data of the lane width of the vehicle traveling lane in the captured image analyzed by the lane width temporal change analyzer 132, for example, a change amount per unit time of the lane width of the vehicle traveling lane in the captured image is equal to or larger than a predetermined threshold value.

Moreover,
(c) The image captured by the camera 12 is determined to be a drawing object in a case where the difference between the grant level position corresponding to the grounding object (vehicle or the like) in the captured image analyzed by the ground level analyzer 133 and the grounding position (tire lower end position) of the grounding object such as a vehicle is equal to or larger than a predetermined threshold value.

In a case corresponding to none of these, that is, in a case where there are satisfied all of these conditions:
(a) A change amount per unit time of the FOE (focus of expansion) position in the captured image analyzed by the FOE position temporal change analyzer 131 is smaller than a predetermined threshold value, and
(b) A change amount per unit time of the lane width of the vehicle traveling lane in the captured image analyzed by the lane width temporal change analyzer 132 is smaller than a predetermined threshold value, and
(c) A difference between the grant level position corresponding to the grounding object (vehicle or the like) in the captured image analyzed by the ground level analyzer 133 and the grounding position (tire lower end position) of the grounding object such as a vehicle is smaller than a predetermined threshold value,
the image captured by the camera 12 is determined to be not a drawing object but a real object such as an actual road.

The determination result of the overall determination part 135 of the drawing object determination unit 112, that is, the determination result of whether the image captured by the camera 12 is a real object or a drawing object is output to the vehicle control unit 103 via the output unit 114 of the image signal analysis unit 102, as illustrated in FIG. 5.

The vehicle control unit 103 performs vehicle control on the basis of this determination result.

For example, in a case where it is determined that the image captured by the camera 12 is a drawing object, warning notification processing is performed. Moreover, in a case of automated driving operation, switching to manual driving is requested to the driver, so as to perform a procedure for shifting to manual driving.

Note that the sequence of these processing will be described later with reference to flowcharts.

### [5. Regarding Details of Configuration and Processing of Object Analysis Unit]

Next, details of the configuration and processing of the object analysis unit 113 in the image signal analysis unit 102 illustrated in FIG. 5 will be described.

As described above with reference to FIG. 5, the object analysis unit 113 in the image signal analysis unit 102 illustrated in FIG. 5 analyzes the types, distances, and the like of various objects included in the captured image on the basis of the captured image analysis result by the image analysis unit 111.

For example, object information including the positions, the distances (distances from the camera), the types, and the sizes of various objects that can be obstacles such as an oncoming vehicle, a preceding vehicle, a pedestrian, and a street tree, is analyzed for each object.

Specifically, for example, the processing of determining whether or not the vehicle 10 deviates from a traveling lane, and the processing of analyzing an approach state to an object that is an obstacle to traveling are performed.

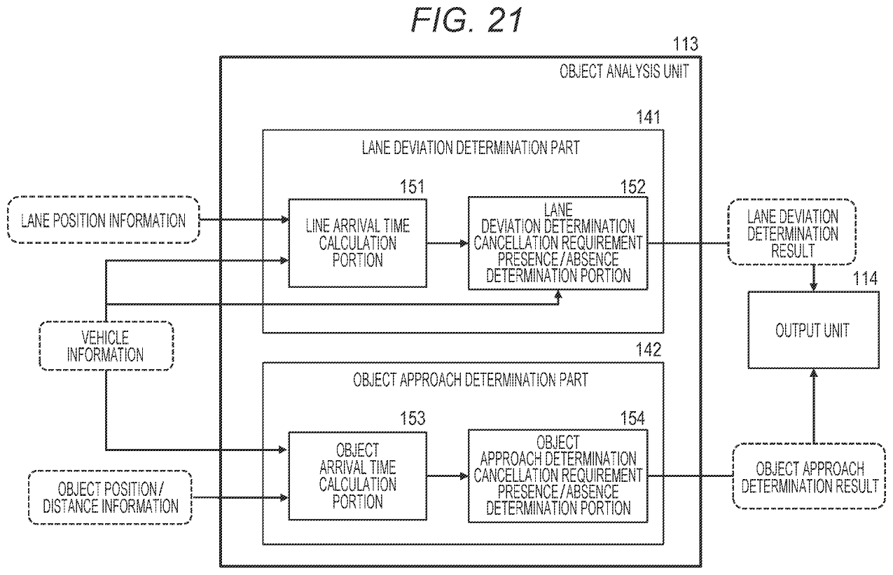

FIG. 21 is a diagram illustrating a detailed configuration of the object analysis unit 113.

As illustrated in FIG. 21, the object analysis unit 113 includes a lane deviation determination part 141 and an object approach determination part 142.

The lane deviation determination part 141 includes a line arrival time calculation portion 151 and a lane deviation determination cancellation requirement presence/absence determination portion 152.

The object approach determination part 142 includes an object arrival time calculation portion 153 and an object approach determination cancellation requirement presence/absence determination portion 154.

The lane deviation determination part 141 performs determination processing of whether or not the vehicle 10 deviates from the traveling lane.

The object approach determination part 142 performs analysis processing of an approach state to an object that is an obstacle to traveling.

The line arrival time calculation portion 151 of the lane deviation determination part 141 inputs each of the following information.
(a) Lane position information of the traveling lane on which the vehicle 10 travels that is detected from the captured image by the lane detector 122 of the image analysis unit 111
(b) Vehicle information input from the vehicle system 200 via the input unit 104 and the control unit 105

On the basis of these pieces of input information, the line arrival time calculation portion 151 of the lane deviation determination part 141 calculates time required for the vehicle 10 to reach the line (side strip, median strip, or the like) recorded at the left and right ends of the road of the traveling lane.

The vehicle information input by the lane deviation determination part 141 includes a traveling direction of the vehicle and a speed of the vehicle.

The line arrival time calculation portion 151 calculates time required for the vehicle 10 to reach the left and right lines (side strip, median strip, or the like) of the traveling lane on the basis of the vehicle information and the lane position information of the traveling lane on which the vehicle 10 travels that is detected from the captured image by the lane detector 122 of the image analysis unit 111.

The calculated time information is input to the lane deviation determination cancellation requirement presence/absence determination portion 152.

The lane deviation determination cancellation requirement presence/absence determination portion 152 determines whether or not the vehicle 10 deviates from the traveling lane on the basis of a proper reason. That is, there is analyzed whether or not there is a proper reason for the vehicle 10 to deviate from the traveling lane and exceed the line.

For example, the vehicle 10 attempts to change the traveling lane by outputting a signal by a direction indicator. Alternatively, the driver tries to change the traveling lane by operating a steering wheel (handle). In such cases, it is determined that the deviation from the traveling lane is occurred on the basis of a proper reason.

Note that vehicle information is also input to the lane deviation determination cancellation requirement presence/absence determination portion 152 from the vehicle system 200 via the control unit 105, so that the output state of the direction indicator, the operation state of the steering, and the like are analyzed, and then the determination processing of whether the deviation from the traveling lane is occurred on the basis of a proper reason is performed.

Upon determining that the lane deviation is not occurred on the basis of a proper reason, the lane deviation determination cancellation requirement presence/absence determination portion 152 outputs a lane deviation determination result of “risk of lane deviation” to the vehicle control unit 103 via the output unit 114 once the line arrival time calculated by the line arrival time calculation portion 151 becomes equal to or smaller than a predetermined threshold time.

Upon inputting the lane deviation determination result of “risk of lane deviation” from the lane deviation determination part 141, the vehicle control unit 103 performs travel control by automated driving so that the vehicle 10 does not deviate from the lane on which the vehicle 10 is traveling. For example, steering adjustment and speed adjustment are performed. Moreover, a warning output or the like to the driver may be performed.

The following will describe the processing performed by the object approach determination part 142.

The object approach determination part 142 performs analysis processing of an approach state to an object that is an obstacle to traveling.

The line arrival time calculation portion 153 of the object approach determination part 142 inputs each of the following information.
(a) Object information including a position and distance of an object detected from the captured image by the object detector 121 of the image analysis unit 111
(b) Vehicle information input from the vehicle system 200 via the input unit 104 and the control unit 105

Note that the above-described (a) object information is object information including positions and distances of various objects such as an oncoming vehicle, a preceding vehicle, a pedestrian, and a street tree that can be obstacles to safe traveling of the vehicle 10.

On the basis of the input information of the above-described (a) and (b), the object arrival time calculation portion 153 of the object approach determination part 142 calculates time required for the vehicle 10 to reach the position of the object detected from the captured image.

The vehicle information input by the object approach determination part 142 includes the traveling direction of the vehicle and the speed of the vehicle.

The object arrival time calculation portion 153 calculates time required for the vehicle 10 to reach the object on the basis of these pieces of vehicle information and the position and distance information of the object detected from the captured image by the object detector 122 of the image analysis unit 111.

The calculated time information is input to the object approach determination cancellation requirement presence/absence determination portion 154.

The object approach determination cancellation requirement presence/absence determination portion 154 determines whether or not the vehicle 10 approaches the object on the basis of a proper reason. That is, there is analyzed whether or not there is a proper reason for the vehicle 10 to approach the object.

For example, in a case where the driver tries to pass the preceding vehicle (approaching object) by stepping on the accelerator while operating the steering wheel (handlebars), it is determined that the approach to the traveling object is performed on the basis of a proper reason.

Note that the vehicle information is also input to the object approach determination cancellation requirement presence/absence determination portion 154 from the vehicle system 200 via the control unit 105, and the output state of the direction indicator, the operation state of the steering, and the like are analyzed to determine whether the approach to the object is performed on the basis of a proper reason.

Upon determining that the approach to the object is not performed on the basis of a proper reason, the object approach determination cancellation requirement presence/absence determination portion 154 performs the following processing.

That is, once the arrival time t0 the object calculated by the object arrival time calculation portion 153 becomes equal to or smaller than a predetermined threshold time, the object approach determination result of “risk of object approach” is output to the vehicle control unit 103 via the output unit 114.

In a case where the object approach determination result of “risk of object approach” is input from the object approach determination part 142, the vehicle control unit 103 performs travel control by automated driving so that the vehicle 10 does not excessively approach the object. For example, steering adjustment and speed adjustment are performed. Moreover, a warning output or the like to the driver may be performed.

### [6. Regarding Sequence of Processing Executed by Image Signal Processing Device According to Present Disclosure]

Next, a sequence of processing executed by the image signal processing difference device according to the present disclosure will be described.

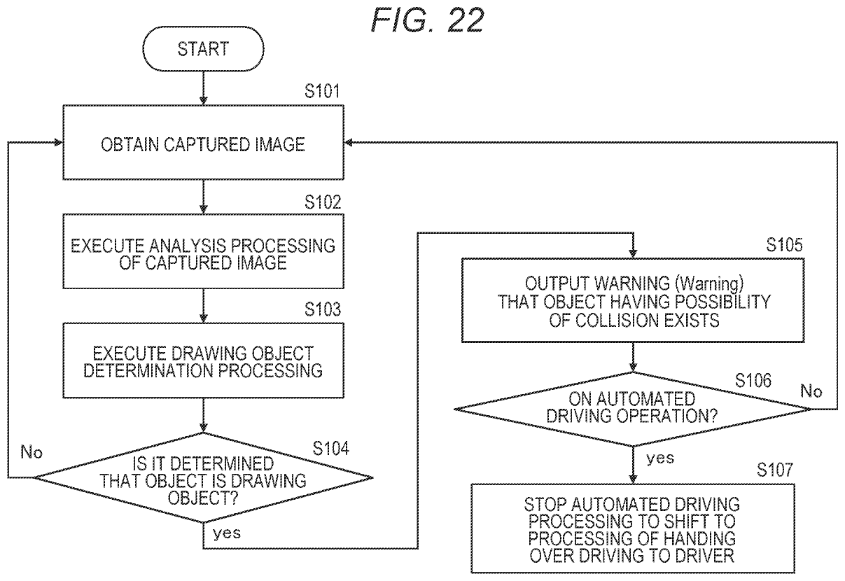

FIG. 22 is a flowchart for describing a sequence of processing performed by the image signal processing device according to the present disclosure, that is, the image signal processing device 100 described above with reference to FIG. 5.

Note that the flowchart illustrated in FIG. 22 is a flowchart mainly describing processing of the drawing object determination unit 112 in the image signal analysis unit 102 of the image signal processing device 100.

That is, the flowchart is for mainly describing the processing of determining whether an image captured by the camera 12 (camera including the image sensor 101) mounted on the vehicle 10 is an image of a real object including an actual road or the like or a drawing object such as a photograph or a picture drawn on a wall and the processing based on the determination result.

Note that the processing according to the flowchart illustrated in FIG. 22 can be executed, for example, according to a program stored in the storage unit of the image signal processing device 100.

The image signal processing device 100 includes a processor such as a CPU having a program execution function, and can execute the processing according to the flowchart illustrated in FIG. 22 in accordance with the program stored in the storage unit.

Hereinafter, processing of each step of the flowchart will be described.

### (Step S101)

First, at Step S101, the image signal analysis unit 102 of the image signal processing device 100 inputs an image captured by the camera 12 (camera having the image sensor 101) mounted on the vehicle 10.

Note that the image sensor (image pickup unit) 101 is an image sensor in the camera 12 mounted on the vehicle 10 illustrated in FIG. 1, and captures an image in the traveling direction of the vehicle 10.

Note that the camera 12 used in the signal processing device 100 of the present disclosure is a monocular camera. An image captured by the image sensor (image pickup unit) 101 in the monocular camera is input to the image signal analysis unit 102.

### (Step S102)

Next, at Step S102, the image signal analysis unit 102 executes analysis processing of the input image captured by the camera.

This processing is processing executed by the image analysis unit 111 in the image processing unit 102 illustrated in FIG. 5.

The image analysis unit 111 executes analysis processing of a captured image input from the image sensor (image pickup unit) 101. As described above with reference to FIG. 5, FIG. 6, and the like, there are executed specifically these processing:
(a) Object detection processing
(b) Lane detection processing
(c) FOE (focus of expansion) position detection processing
(d) Ground level detection processing
(e) Vehicle traveling direction detection processing

That is, as described with reference to FIG. 6 to FIG. 10,
the object detector 121 of the image analysis unit 111 analyzes the types, distances, and the like of various objects included in the captured image input from the image sensor (image pickup unit) 101.

For example, object information including the positions, the distances (distances from the camera), the types, and the sizes of various objects that can be obstacles such as an oncoming vehicle, a preceding vehicle, a pedestrian, and a street tree, is analyzed for each object.

Furthermore, the lane detector 122 of the image analysis unit 111 analyzes the captured image input from the image sensor (image pickup unit) 101, and detects a lane on which the vehicle is traveling.

Furthermore, the FOE (focus of expansion) position detector 123 of the image analysis unit 111 analyzes the captured image input from the image sensor (image pickup unit) 101, and detects a FOE (focus of expansion) position in the captured image.

Moreover, the ground level detector 124 of the image analysis unit 111 analyzes the captured image input from the image sensor (image pickup unit) 101, and detects a ground level (road surface position) in the captured image.

Moreover, the vehicle traveling direction detector 125 determines whether or not the vehicle 10 is traveling in the optical axis direction of the camera 12 mounted on the vehicle 10 on the basis of the captured image input from the camera 12 (camera including the image sensor 101) mounted on the vehicle 10 and the vehicle information input from the vehicle system 200 via the input unit and the control unit 195.

### (Step S103)

Next, at Step S103, the image signal processing device 102 executes drawing object determination processing.

This processing is processing executed by the drawing object determination unit 112 in the image signal analysis unit 102 illustrated in FIG. 5.

As described above, the drawing object determination unit 112 determines whether the object included in the image captured by the camera 12 (camera including the image sensor 101) mounted on the vehicle 10 is an actual object or a drawing object such as a photograph or a picture on the basis of the captured image analysis result by the image analysis unit 111.

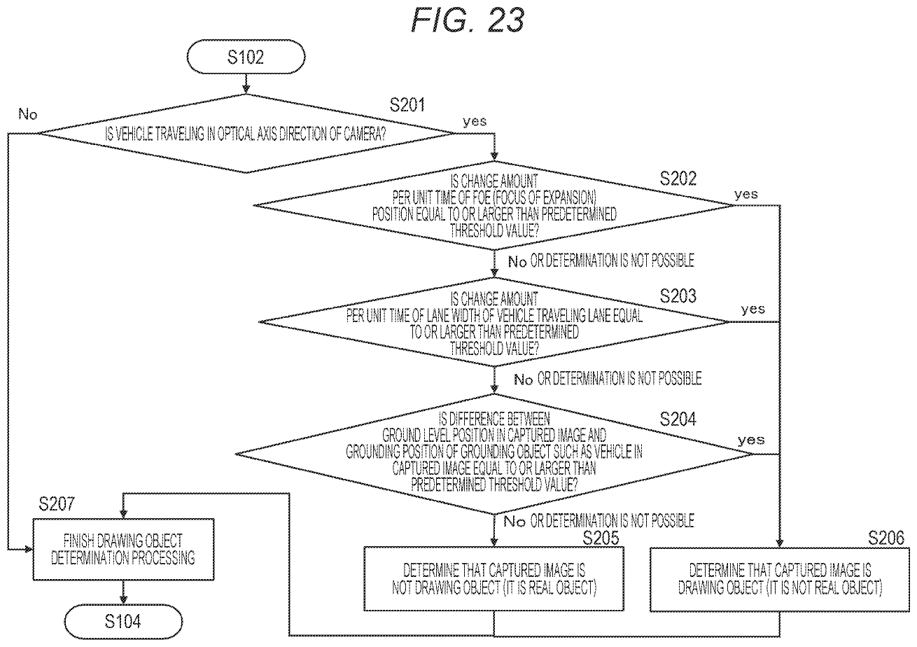

A detailed sequence of the processing at Step S103 will be described later with reference to the flowchart illustrated in FIG. 23.

### (Step S104)

Step S104 is a branch processing based on the determination result of the drawing object determination processing at Step S103.

In a case where it is determined in the drawing object determination processing at Step S103 that the object included in the image captured by the camera 12 mounted on the vehicle 10 is a real object such as an actual road, the determination processing result at Step S104 is No, so that the processing returns to Step S101, and the processing from Step S101 is repeated.

That is, the analysis processing of a new captured image is started.

On the other hand, in a case where it is determined in the drawing object determination processing at Step S103 that the object included in the image captured by the camera 12 mounted on the vehicle 10 is not a real object such as an actual road but a drawing object such as a photograph or a picture, the determination processing result at Step S104 is Yes, so that the processing proceeds to Step S105.

### (Step S105)

In a case where it is determined at Step S104 that the object included in the image captured by the camera 12 is not a real object such as an actual road but a drawing object such as a photograph or a picture, the processing at Step S105 is executed.

In this case, at Step S105, the image signal analysis unit 102 notifies the vehicle control unit that the object included in the image captured by the camera 12 is not a real object such as an actual road but a drawing object such as a picture or a drawing.

In response to this notification, the vehicle control unit 103 issues a warning to the driver of the vehicle 10. That is, a warning that an object having a possibility of collision exists is output.

### (Step S106)

Moreover, at Step S106, the vehicle control unit 103 determines whether the vehicle 110 is currently on automated driving operation or manual driving operation.

In a case where the vehicle 110 is not on automated driving operation, that is, in a case where it is on manual driving operation, the processing returns to Step S101, so as to shift to the processing on a new captured image.

On the other hand, in a case where the vehicle 10 is on automated driving operation, the processing proceeds to Step S107.

### (Step S107)

The processing of Step S107 is processing performed in a case where the vehicle 10 is on automated driving operation.

In a case where the vehicle 10 is currently on automated driving operation, the vehicle control unit 103 stops the automated driving processing to shift to a start procedure of driving-subject handover (transition) processing for causing the driver to perform manual driving.

Thereafter, the driving is switched from automated driving to manual driving, and the vehicle 10 is controlled under the forward checking by the driver, thereby allowing the vehicle 10 to be safely stopped without colliding with the drawing object such as a photograph or a picture.

Note that in a case where it is detected that the switching to manual driving is not smoothly executed, processing for emergency stop of the vehicle 10 or the like is performed.

Next, a detailed sequence of the processing at Step S103, that is, the drawing object determination processing will be described with reference to the flowchart illustrated in FIG. 23.

As described above, this processing is processing executed by the drawing object determination unit 112 in the image signal analysis unit 102 illustrated in FIG. 5.

The drawing object determination unit 112 determines whether the object included in the image captured by the camera 12 (camera including the image sensor 101) mounted on the vehicle 10 is an actual object or a drawing object such as a photograph or a picture on the basis of the captured image analysis result by the image analysis unit 111.

Hereinafter, processes of respective steps of the flow illustrated in FIG. 23 will be described in order.

### (Step S201)

First, at Step S201, the image signal analysis unit 102 determines whether or not the vehicle 10 is traveling in the optical axis direction of the camera 12 mounted on the vehicle 10.

This determination processing is performed on the basis of the detection result by the vehicle traveling direction detector 125 in the image analysis unit 111 of the image signal analysis unit 102 described with reference to FIG. 5 and FIG. 6.

The vehicle traveling direction detector 125 determines whether or not the vehicle 10 is traveling in the optical axis direction of the camera 12 mounted on the vehicle 10 on the basis of the captured image input from the camera 12 (camera including the image sensor 101) mounted on the vehicle 10 and the vehicle information input from the vehicle system 200 via the input unit and the control unit 195.

The vehicle traveling direction analysis information as the determination result is input to the drawing object determination unit 112.

In a case where the vehicle 10 is not traveling in the optical axis direction of the camera 12, the processing of Step S202 and the subsequent steps is not performed.

That is, the processing of determining whether the object included in the image captured by the camera 12 is an actual object or a drawing object such as a photograph or a picture is not performed.

As described above, in a case where the vehicle 10 is not traveling in the optical axis direction of the camera 12, it is difficult to perform processing of determining whether an object in the captured image is an actual object or a drawing object such as a photograph or a picture on the basis of the image captured by the camera 12.

In this case, the processing proceeds to Step S207, so that the drawing object determination processing is stopped, and the processing proceeds to Step S104 of the flow illustrated in FIG. 22.

Note that, in this case, the determination at Step S104 is No, and the processing returns to Step S101 to shift to the processing for the next captured image.

In a case where the vehicle 10 is traveling in the optical axis direction of the camera 12, the processing of Step S202 and the subsequent steps is performed.

This is because, in a case where the vehicle 10 is traveling in the optical axis direction of the camera 12, it is possible to perform processing of determining whether an object in the captured image is an actual object or a drawing object such as a photograph or a picture on the basis of the image captured by the camera 12.

### (Step S202)

The processing of Steps S202 to S206 is executed in a case where it is determined at Step S201 that the vehicle 10 is traveling in the optical axis direction of the camera 12 mounted on the vehicle 10.

In this case, first, at Step S202, there is determined whether or not the change amount per unit time of the FOE (focus of expansion) position detected from the captured image of the camera 12 mounted on the vehicle 10 is equal to or larger than a predetermined threshold value.

This processing is processing executed by the FOE position temporal change analyzer 131 and the overall determination part 135 in the drawing object determination unit 112 illustrated in FIG. 11.

In a case where the change amount per unit time of the FOE (focus of expansion) position is equal to or larger than the predetermined threshold value, the determination at Step S202 is Yes, and the processing proceeds to Step S206.

In this case, at Step S206, it is determined that the object included in the image captured by the camera 12 (camera including the image sensor 101) mounted on the vehicle 10 is not an actual object but a drawing object such as a photograph or a picture.

On the other hand, in a case where the change amount per unit time of the FOE (focus of expansion) position is smaller than the predetermined threshold value, the determination at Step S202 is No, and the processing proceeds to Step S203.

Note that, also in a case where the determination processing at Step S202 is not possible, for example, in a case where the FOE (focus of expansion) position cannot be detected from the captured image, the processing proceeds to Step S203.

### (Step S203)

In a case where, in the determination processing of Step S202, the change amount per unit time of the FOE (focus of expansion) position is smaller than the predetermined threshold value, that is, in a case where the determination result of Step S202 is No, or in a case where the determination result of the determination processing at Step S202 is not obtained, the processing proceeds to Step S203.

In this case, at Step S203, the drawing object determination unit 112 determines whether or not the change amount per unit time of the lane width of the vehicle traveling lane detected from the image captured by the camera 12 mounted on the vehicle 10 is equal to or larger than a predetermined threshold value.

This processing is processing executed by the lane width temporal change analyzer 132 and the overall determination part 135 in the drawing object determination unit 112 illustrated in FIG. 11.

In a case where the change amount per unit time of the lane width of the vehicle traveling lane is equal to or larger than the predetermined threshold value, the determination at Step S203 is Yes, and the processing proceeds to Step S206.

In this case, at Step S206, it is determined that the object included in the image captured by the camera 12 (camera including the image sensor 101) mounted on the vehicle 10 is not an actual object but a drawing object such as a photograph or a picture.

On the other hand, in a case where the change amount per unit time of the lane width of the vehicle traveling lane is smaller than the predetermined threshold value, the determination at Step S203 is No, and the processing proceeds to Step S204.

Note that also in a case where the determination processing at Step S203 is not possible, for example, in a case where the lane width of the vehicle traveling lane cannot be detected from the captured image, the processing proceeds to Step S204.

### (Step S204)

In a case where, in the determination processing of Step S203, the change amount per unit time of the lane width of the vehicle traveling lane is smaller than the predetermined threshold value, that is, in a case where the determination result of Step S203 is No, or in a case where the determination result of the determination processing at Step S203 is not obtained, the processing proceeds to Step S204.

In this case, at Step S204, the drawing object determination unit 112 first estimates a ground level position corresponding to the grounding position of the grounding object (vehicle or the like) from the size of the grounding object such as a vehicle in the image captured by the camera 12 mounted on the vehicle 10.

Moreover, a difference between the estimated grant level position and the grounding position (tire lower end position) of the grounding object such as a vehicle is calculated so as to determine whether or not the difference is equal to or larger than a predetermined threshold value.

This processing is processing executed by the ground level analyzer 133 and the overall determination part 135 in the drawing object determination unit 112 illustrated in FIG. 11.

In a case where the difference between the grant level position estimated from the size of the grounding object such as a vehicle and the grounding position (tire lower end position) of the grounding object such as a vehicle is equal to or larger than a predetermined threshold value, the determination at Step S204 is Yes, and the process proceeds to Step S206.

In this case, at Step S206, it is determined that the object included in the image captured by the camera 12 (camera including the image sensor 101) mounted on the vehicle 10 is not an actual object but a drawing object such as a photograph or a picture.

On the other hand, in a case where the difference between the grant level position estimated from the size of the grounding object such as a vehicle and the grounding position (tire lower end position) of the grounding object such as a vehicle is smaller than a predetermined threshold value, the determination at Step S204 is No, and the process proceeds to Step S205.

Note that also in a case where the determination processing at Step S204 is not possible, for example, in a case where the grounding object such as a vehicle cannot be detected from the captured image or in a case where the ground level position cannot be detected, the processing proceeds to Step S205.

### (Step S205)

At Step S205, the drawing object determination unit 112 determines that the image captured by the camera 12 is not a drawing object, that is, is a real object such as an actual road or the like.

In a case where it is determined at Step S205 that the image captured by the camera 12 is not a drawing object but a real object, or in a case where it is determined at Step S206 that the image captured by the camera 12 is a drawing object, the processing proceeds to Step S207.

At Step S207, the drawing object determination processing is finished, so that the processing proceeds to Step S104 of the flow illustrated in FIG. 22.

By performing the processing in accordance with the flow illustrated in FIG. 23, the drawing object determination unit 112 determines whether the image captured by the camera 12 mounted on the vehicle 10 is a real object such as an actual road or the like, or a drawing object such as a photograph or a picture drawn on a wall or the like.

The vehicle control unit 103 performs vehicle control on the basis of this determination result.

For example, in a case where it is determined that the image captured by the camera 12 is a drawing object, warning notification processing is performed. Moreover, in a case of automated driving operation, switching to manual driving is requested to the driver, so as to perform a procedure for shifting to manual driving.

With such processing, it is possible to prevent an automated vehicle from erroneously colliding with a wall or the like.

### [7. Regarding Hardware Configuration Example of Signal Processing Device According to Present Disclosure]

The following will describe a hardware configuration example of the signal processing device 100 of the present disclosure that executes the above-described processing.

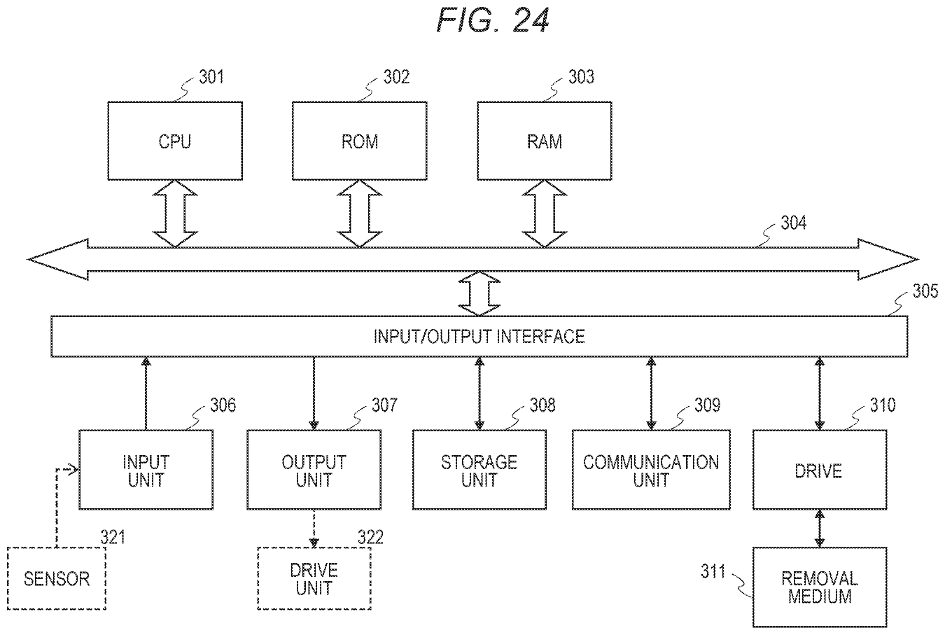

FIG. 24 is an example of a hardware configuration of the signal processing device 100 mounted in a mobile device that executes the above-described processing.

Hereinafter, each component of the hardware configuration example illustrated in FIG. 24 will be described.

A central processing unit (CPU) 301 functions as a data processing unit that executes various types of processing in accordance with a program stored in a read only memory (ROM) 302 or a storage unit 308. For example, the CPU 301 executes the processing according to the sequence described in the above embodiment. A random access memory (RAM) 303 stores programs, data, or the like to be performed by the CPU 301. The CPU 301, the ROM 302, and the RAM 303 are connected to each other by a bus 304.

The CPU 301 is connected to an input/output interface 305 via the bus 304, and to the input/output interface 305, an input unit 306 that includes various switches, a keyboard, a touch panel, a mouse, a microphone, a status data obtaining unit such as a sensor, a camera, a GPS, and the like, and an output unit 307 that includes a display, a speaker, and the like are connected.

Note that input information from a sensor 321 such as a distance sensor or a camera is also input to the input unit 306.

Furthermore, the output unit 307 also outputs an object distance, position information, and the like as information for a drive unit 322 that drives the vehicle.

The CPU 301 inputs commands, status data, or the like input from the input unit 306, executes various types of processing, and outputs processing results to, for example, the output unit 307.

The storage unit 308 connected to the input/output interface 305 includes, for example, a hard disk, or the like and stores programs executed by the CPU 301 and various types of data. A communication unit 309 functions as a transmitter and receiver for data communication via a network such as the Internet or a local area network, and communicates with an external device.

A drive 310 connected to the input/output interface 305 drives a removable medium 311 such as a magnetic disk, an optical disk, a magneto-optical disk, or a semiconductor memory such as a memory card, and records or reads data.

### [8. Conclusion of Configuration of Present Disclosure]

Hereinabove, the embodiments according to the present disclosure have been described in detail with reference to the specific embodiments. However, it is obvious that those skilled in the art can modify or substitute the embodiments without departing from the gist of the present disclosure. That is, the present invention has been disclosed in the form of exemplification, and should not be interpreted in a limited manner. In order to determine the gist of the present disclosure, the claims should be considered.

Note that the technology disclosed herein can have the following configurations.

(1) A signal processing device including an image signal analysis unit configured to input a captured image captured by a monocular camera mounted on a vehicle, and determine whether an object in the captured image is a real object or a drawing object by image analysis of the input captured image.

(2) The signal processing device according to (1), in which
the image signal analysis unit includes a FOE (focus of expansion) position detector configured to detect a FOE (focus of expansion) position from the captured image, and
a drawing object determination unit configured to determine whether the object in the captured image is a real object or a drawing object on the basis of a temporal change of a FOE (focus of expansion) position detected by the FOE (focus of expansion) position detector, and
the drawing object determination unit determines, in a case where a change amount per unit time of a FOE (focus of expansion) position is equal to or larger than a predetermined threshold value, that the object in the captured image is a drawing object.

(3) The signal processing device according to (2), in which
the drawing object determination unit analyzes a plurality of time-series images captured by the monocular camera to calculate a change amount per unit time of a FOE (focus of expansion) position, and
determines, in a case where the change amount per unit time of the FOE (focus of expansion) position calculated by analyzing the plurality of time-series images is equal to or more than a predetermined threshold value, that the object in the captured image is a drawing object.

(4) The signal processing device according to (2) or (3), in which
the FOE (focus of expansion) position detector detects a point at infinity where a plurality of lines recorded on a straight road intersect in a captured image as a FOE (focus of expansion) position.

(5) The signal processing device according to any one of (1) to (4), in which
the image signal analysis unit includes
a lane detector configured to detect a traveling lane on which the vehicle travels from the captured image, and
a drawing object determination unit configured to determine whether an object in the captured image is a real object or a drawing object on the basis of a temporal change of a lane width of the traveling lane detected by the lane detector, and
the drawing object determination unit determines, in a case where a change amount per unit time of a lane width is equal to or larger than a predetermined threshold value, that the object in the captured image is a drawing object.

(6) The signal processing device according to (5), in which
the drawing object determination unit analyzes a plurality of time-series images captured by the monocular camera to calculate a change amount per unit time of a lane width, and
determines, in a case where the change amount per unit time of a lane width calculated by analyzing the plurality of time-series images is equal to or larger than a predetermined threshold value, that the object in the captured image is a drawing object.

(7) The signal processing device according to any one of (1) to (6), in which
the image signal analysis unit includes
a ground level detector configured to detect a ground level from the captured image, and
a drawing object determination unit configured to determine whether the object in the captured image is a real object or a drawing object on the basis of a difference between a grounding position of a grounding object in the captured image and a ground level position corresponding to the grounding position of the grounding object, and
the drawing object determination unit determines, in a case where the difference between the grounding position of the grounding object in the captured image and the ground level position corresponding to the grounding position of the grounding object is equal to or larger than a predetermined threshold value, that the object in the captured image is a drawing object.

(8) The signal processing device according to (7), in which
the drawing object determination unit
analyzes a plurality of time-series images captured by the monocular camera to detect a difference between a grounding position of a grounding object in the captured image and a ground level position corresponding to the grounding position of the grounding object, and
determines, in a case where the difference between the grounding position of the grounding object in the captured image and the ground level position corresponding to the grounding position of the grounding object is equal to or larger than a predetermined threshold value, that the object in the captured image is a drawing object.

(9) The signal processing device according to (7) or (8), in which
the grounding object is a preceding vehicle preceding the vehicle or an oncoming vehicle, and
the grounding position of the grounding object is a tire lower end position of the preceding vehicle or the oncoming vehicle.

(10) The signal processing device according to any one of (7) to (9), in which
the drawing object determination unit calculates a ground level position corresponding to the grounding position of the grounding object on the basis of a size of the grounding object in the captured image, or obtains the ground level position from a storage unit.

(11) The signal processing device according to any one of (1) to (10), in which
the image signal analysis unit determines, in a case where
a change amount per unit time of a FOE (focus of expansion) position detected from the captured image is smaller than a predetermined threshold value, and
a change amount per unit time of a lane width of a traveling lane on which the vehicle travels detected from the captured image is smaller than a predetermined threshold value, and
a difference between a ground level detected from the captured image and a grounding position of a grounding object in the captured image is smaller than a predetermined threshold value,
that the object in the captured image is a real object.

(12) The signal processing device according to any one of (1) to (11), in which
the image signal analysis unit includes an image analysis unit configured to determine whether or not the vehicle is traveling in an optical axis direction of the monocular camera, and
the image signal analysis unit executes, in a case where the image analysis unit determines that the vehicle is traveling in the optical axis direction of the monocular camera,
processing of determining whether the object in the captured image is a real object or a drawing object.

(13) The signal processing device according to any one of (1) to (12), in which
the image signal analysis unit outputs a determination result of whether the object in the captured image is a real object or a drawing object to a vehicle control unit, and
the vehicle control unit outputs a warning in a case where the determination result that the object in the captured image is a drawing object is input from the image signal analysis unit.

(14) The signal processing device according to (13), in which
the vehicle control unit starts, in a case where the determination result that the object in the captured image is a drawing object is input from the image signal analysis unit and the vehicle is on automated driving operation,
processing of shifting the vehicle from automated driving to manual driving.

(15) A signal processing method executed in a signal processing device, the method including
executing image signal analysis processing by an image signal analysis unit of inputting a captured image captured by a monocular camera mounted on a vehicle, and determining whether an object in the captured image is a real object or a drawing object by image analysis of the input captured image.

(16) A program causing a signal processing device to execute signal processing, the program causing an image signal analysis unit to perform image signal analysis processing of inputting a captured image captured by a monocular camera mounted on a vehicle, and determining whether an object in the captured image is a real object or a drawing object by image analysis of the input captured image.

Furthermore, a series of processing described herein can be executed by hardware, software, or a configuration obtained by combining hardware and software. In a case where processing by software is executed, a program in which a processing sequence is recorded can be installed and performed in a memory in a computer incorporated in dedicated hardware, or the program can be installed and performed in a general-purpose computer capable of executing various types of processing. For example, the program can be recorded in advance in a recording medium. In addition to being installed in a computer from the recording medium, a program can be received via a network such as a local area network (LAN) or the Internet and installed in a recording medium such as an internal hard disk or the like.

Note that the various types of processing herein may be executed not only in a chronological order in accordance with the description, but may also be executed in parallel or individually depending on processing capability of a device that executes the processing or depending on the necessity. Furthermore, a system herein described is a logical set configuration of a plurality of devices, and is not limited to a system in which devices of respective configurations are in the same housing.

### INDUSTRIAL APPLICABILITY

As described above, with a configuration of an embodiment of the present disclosure, there is realized a configuration of analyzing a captured image captured by a monocular camera and determining whether an object in the captured image is a real object or a drawing object.

Specifically, for example, an image captured by a monocular camera mounted on a vehicle is analyzed to determine whether an object in the captured image is a real object or a drawing object. An image signal analysis unit determines that an object in the captured image is a drawing object in a case where a change amount per unit time of a FOE (focus of expansion) position in the captured image is equal to or larger than a predetermined threshold value, in a case where a change amount per unit time of a lane width detected from the captured image is equal to or larger than a predetermined threshold value, or in a case where a difference between a grounding position of a vehicle or the like in the captured image and a ground level position corresponding to the vehicle grounding position is equal to or larger than a predetermined threshold value.

With this configuration, there is realized a configuration of analyzing a captured image captured by a monocular camera and determining whether an object in the captured image is a real object or a drawing object.

### REFERENCE SIGNS LIST

10 vehicle
12 camera
20 captured image
30 drawing object
40 captured image
100 signal processing device
101 image sensor (image pickup unit)
102 image signal analysis unit
103 vehicle control unit
104 input unit
105 control unit
111 image analysis unit
112 drawing object determination unit
113 object analysis unit
114 output unit
121 object detector
122 lane detector
123 FOE (focus of expansion) position detector
124 ground level detector
125 vehicle traveling direction detector
131 FOE position temporal change analyzer
132 lane width temporal change analysis
133 ground level analyzer
134 reference ground level storage part
135 overall determination part
141 lane deviation determination part
142 object approach determination part
151 line arrival time calculation portion
152 lane deviation determination cancellation requirement presence/absence determination portion
153 object arrival time calculation portion
154 object approach determination cancellation requirement presence/absence determination portion
200 vehicle system
301 CPU
302 ROM
303 RAM
304 bus
305 input/output interface
306 input unit
307 output unit
308 storage unit
309 communication unit
310 drive
311 removable medium
321 sensor
322 drive unit

1. A signal processing device, comprising
an image signal analysis unit configured to input a captured image captured by a monocular camera mounted on a vehicle, and determine whether an object in the captured image is a real object or a drawing object by image analysis of the input captured image.

2. The signal processing device according to claim 1, wherein
the image signal analysis unit includes
a FOE (focus of expansion) position detector configured to detect a FOE (focus of expansion) position from the captured image, and
a drawing object determination unit configured to determine whether the object in the captured image is a real object or a drawing object on a basis of a temporal change of a FOE (focus of expansion) position detected by the FOE (focus of expansion) position detector, and
the drawing object determination unit determines, in a case where a change amount per unit time of a FOE (focus of expansion) position is equal to or larger than a predetermined threshold value, that the object in the captured image is a drawing object.

3. The signal processing device according to claim 2, wherein
the drawing object determination unit analyzes a plurality of time-series images captured by the monocular camera to calculate a change amount per unit time of a FOE (focus of expansion) position, and
determines, in a case where the change amount per unit time of the FOE (focus of expansion) position calculated by analyzing the plurality of time-series images is equal to or more than a specified threshold value, that the object in the captured image is a drawing object.

4. The signal processing device according to claim 2, wherein
the FOE (focus of expansion) position detector detects a point at infinity where a plurality of lines recorded on a straight road intersect in a captured image as a FOE (focus of expansion) position.

5. The signal processing device according to claim 1, wherein
the image signal analysis unit includes
a lane detector configured to detect a traveling lane on which the vehicle travels from the captured image, and
a drawing object determination unit configured to determine whether an object in the captured image is a real object or a drawing object on a basis of a temporal change of a lane width of the traveling lane detected by the lane detector, and
the drawing object determination unit determines, in a case where a change amount per unit time of a lane width is equal to or larger than a predetermined threshold value, that the object in the captured image is a drawing object.

6. The signal processing device according to claim 5, wherein
the drawing object determination unit analyzes a plurality of time-series images captured by the monocular camera to calculate a change amount per unit time of a lane width, and
determines, in a case where the change amount per unit time of a lane width calculated by analyzing the plurality of time-series images is equal to or larger than a predetermined threshold value, that the object in the captured image is a drawing object.

7. The signal processing device according to claim 1, wherein
the image signal analysis unit includes
a ground level detector configured to detect a ground level from the captured image, and
a drawing object determination unit configured to determine whether the object in the captured image is a real object or a drawing object on a basis of a difference between a grounding position of a grounding object in the captured image and a ground level position corresponding to the grounding position of the grounding object, and
the drawing object determination unit determines, in a case where the difference between the grounding position of the grounding object in the captured image and the ground level position corresponding to the grounding position of the grounding object is equal to or larger than a predetermined threshold value, that the object in the captured image is a drawing object.

8. The signal processing device according to claim 7, wherein
the drawing object determination unit
analyzes a plurality of time-series images captured by the monocular camera to detect a difference between a grounding position of a grounding object in the captured image and a ground level position corresponding to the grounding position of the grounding object, and
determines, in a case where the difference between the grounding position of the grounding object in the captured image and the ground level position corresponding to the grounding position of the grounding object is equal to or larger than a predetermined threshold value, that the object in the captured image is a drawing object.

9. The signal processing device according to claim 7, wherein
the grounding object is a preceding vehicle preceding the vehicle or an oncoming vehicle, and
the grounding position of the grounding object is a tire lower end position of the preceding vehicle or the oncoming vehicle.

10. The signal processing device according to claim 7, wherein
the drawing object determination unit calculates a ground level position corresponding to the grounding position of the grounding object on a basis of a size of the grounding object in the captured image, or obtains the ground level position from a storage unit.

11. The signal processing device according to claim 1, wherein
the image signal analysis unit determines, in a case where
a change amount per unit time of a FOE (focus of expansion) position detected from the captured image is smaller than a predetermined threshold value, and
a change amount per unit time of a lane width of a traveling lane on which the vehicle travels detected from the captured image is smaller than a predetermined threshold value, and
a difference between a ground level detected from the captured image and a grounding position of a grounding object in the captured image is smaller than a predetermined threshold value,
that the object in the captured image is a real object.

12. The signal processing device according to claim 1, wherein
the image signal analysis unit includes an image analysis unit configured to determine whether or not the vehicle is traveling in an optical axis direction of the monocular camera, and
the image signal analysis unit executes, in a case where the image analysis unit determines that the vehicle is traveling in the optical axis direction of the monocular camera,
processing of determining whether the object in the captured image is a real object or a drawing object.

13. The signal processing device according to claim 1, wherein
the image signal analysis unit outputs a determination result of whether the object in the captured image is a real object or a drawing object to a vehicle control unit, and
the vehicle control unit outputs a warning in a case where the determination result that the object in the captured image is a drawing object is input from the image signal analysis unit.

14. The signal processing device according to claim 13, wherein
the vehicle control unit starts, in a case where the determination result that the object in the captured image is a drawing object is input from the image signal analysis unit and the vehicle is on automated driving operation,
processing of shifting the vehicle from automated driving to manual driving.

15. A signal processing method executed in a signal processing device, the method including
executing image signal analysis processing by an image signal analysis unit of inputting a captured image captured by a monocular camera mounted on a vehicle, and determining whether an object in the captured image is a real object or a drawing object by image analysis of the input captured image.

16. A program causing a signal processing device to execute signal processing, the program causing an image signal analysis unit to perform image signal analysis processing of inputting a captured image captured by a monocular camera mounted on a vehicle, and determining whether an object in the captured image is a real object or a drawing object by image analysis of the input captured image.
